(19) United States
(12) Patent Application Publication
(10) Pub. No.: US 2026/0323351 A1
(43) Pub. Date: Oct. 15, 2026

(54) EVENT REPORTING FOR ARTIFICIAL INTELLIGENCE OR MACHINE LEARNING MODEL MONITORING

(71) Applicant: QUALCOMM Incorporated, San Diego, CA (US)

(72) Inventors: Hamed PEZESHKI, San Diego, CA (US); Qiaoyu LI, Beijing (CN); Mahmoud TAHERZADEH BOROUJENI, San Diego, CA (US)

(21) Appl. No.: 19/474,048

(22) PCT Filed: May 25, 2023
(86) PCT No.: PCT/CN2023/096188

§ 371 Date: Oct. 9, 2025

(51) Int. Cl. H04W 24/10; H04L 41/16; H04W 24/08

(52) U.S. Cl. CPC H04W 24/10; H04L 41/16; H04W 24/08

(57) ABSTRACT

Various aspects of the present disclosure generally relate to wireless communication. In some aspects, a user equipment (UE) may receive configuration information indicating a plurality of events that are associated with artificial intelligence or machine learning (AI/ML) model monitoring, each event of the plurality of events associated with a respective criterion of a plurality of criteria. The UE may identify, according to one or more criteria of the plurality of criteria, that a set of events, of the plurality of events, corresponding to the one or more criteria have occurred. The UE may transmit a report indicating that the set of events have occurred. Numerous other aspects are described.

### FIELD OF THE DISCLOSURE

Aspects of the present disclosure generally relate to wireless communication and to techniques and apparatuses for event reporting for artificial intelligence or machine learning model monitoring.

### BACKGROUND

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and types of wireless communications mediums available for use, and the like. Consequently, there exists a need for further improvements in wireless communications systems to overcome the aforementioned technical challenges and others.

### SUMMARY

Some aspects described herein relate to a method of wireless communication performed by a user equipment (UE). The method may include receiving configuration information indicating a plurality of events that are associated with artificial intelligence or machine learning (AI/ML) model monitoring, each event of the plurality of events associated with a respective criterion of a plurality of criteria. The method may include identifying, according to one or more criteria of the plurality of criteria, that a set of events, of the plurality of events, corresponding to the one or more criteria have occurred. The method may include transmitting a report indicating that the set of events have occurred.

Some aspects described herein relate to a method of wireless communication performed by a network entity. The method may include transmitting configuration information indicating a plurality of events associated with AI/ML model monitoring, each event of the plurality of events associated with a respective criterion of a plurality of criteria. The method may include receiving a report indicating that a set of events, of the plurality of events, have occurred according to one or more criteria, of the plurality of criteria, corresponding to the set of events.

Other aspects provide: an apparatus operable, configured, or otherwise adapted to perform any one or more of the aforementioned methods and/or those described herein with reference to and as illustrated by the drawings; a non-transitory, computer-readable medium comprising computer-executable instructions that, when executed by a processor of an apparatus, cause the apparatus to perform the aforementioned methods and/or those described herein with reference to and as illustrated by the drawings; a computer program product embodied on a computer-readable storage medium comprising code for performing the aforementioned methods and/or those described herein with reference to and as illustrated by the drawings; and/or an apparatus comprising means for performing the aforementioned methods and/or those described herein with reference to and as illustrated by the drawings. By way of example, an apparatus may comprise a processing system, a device with a processing system, or processing systems cooperating over one or more networks.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 depicts an example of a wireless communications network, in accordance with the present disclosure.

FIG. 2 depicts aspects of an example base station and user equipment (UE), in accordance with the present disclosure.

FIG. 3 depicts an example disaggregated base station architecture, in accordance with the present disclosure.

FIGS. 4A, 4B, 4C, and 4D depict aspects of data structures for a wireless communications network, in accordance with the present disclosure.

FIG. 5 is a diagram illustrating examples of channel state information reference signal (CSI-RS) beam management procedures, in accordance with the present disclosure.

FIG. 6 is a diagram illustrating an example architecture of a functional framework for radio access network (RAN) intelligence enabled by data collection, in accordance with the present disclosure.

FIG. 7 is a diagram illustrating an example of artificial intelligence or machine learning models, in accordance with the present disclosure.

FIG. 8 is a diagram illustrating an example of beam management, in accordance with the present disclosure.

FIG. 9 is a diagram illustrating an example of signaling for hybrid performance monitoring using a combination of events, in accordance with the present disclosure.

FIG. 10 is a flowchart of an example method of wireless communication.

FIG. 11 is a flowchart of an example method of wireless communication.

FIG. 12 is a diagram illustrating an example of an implementation of code and circuitry for a communications device, in accordance with the present disclosure.

FIG. 13 is a diagram illustrating an example of an implementation of code and circuitry for a communications device, in accordance with the present disclosure.

### DETAILED DESCRIPTION

Aspects of the present disclosure provide apparatuses, methods, processing systems, and computer-readable mediums for event reporting for artificial intelligence or machine learning (AI/ML) model monitoring.

A network entity or a user equipment (UE) may perform performance monitoring for a UE-side AI/ML model. Performance monitoring can be network-side (in which a network entity performs performance monitoring), UE-side (in which a UE performs performance monitoring), or hybrid (in which the UE and the network entity collaboratively determine performance of an AI/ML model). A UE or network entity may perform performance monitoring according to certain key performance indicators (KPIs). In the case of hybrid performance monitoring, a UE may report information to a network entity based on a criterion corresponding to a KPI, such as for AI/ML based beam management (BM). However, a single KPI/criterion may provide inaccurate or incomplete information regarding performance of an AI/ML model (such as a functionality-based lifecycle management (LCM) model). For example, a beam prediction accuracy KPI/criterion may seem to indicate that performance of an AI/ML model for beam prediction is unsatisfactory, but another KPI/criterion (such as a throughput or a Layer 1 reference signal received power (L1-RSRP)) may indicate that communication performance at the UE is satisfactory in spite of the beam prediction accuracy KPI. Therefore, performance monitoring according to a single KPI (such as reporting according to a single KPI at the UE, or performing LCM operations such as deactivating AI/ML functionality according to a single KPI at the network entity) may lead to inefficient AI/ML based BM, thereby leading to radio link failure (RLF).

Various aspects relate generally to performance monitoring for AI/ML based BM, such as hybrid performance monitoring. Some aspects more specifically relate to performance monitoring according to a combination of criteria. In some examples, a UE may transmit a report indicating that a set of events, associated with a respective set of criteria, have occurred. The set of events may be associated with AI/ML model monitoring. In some examples, the set of events may include multiple events, such that the UE transmits the reports upon a combination of events occurring. In some other examples, the set of events may include a single event (e.g., the UE may report individual events as the events occur), and the network entity may perform an LCM operation according to a combination of reported events.

Particular aspects of the subject matter described in this disclosure can be implemented to realize one or more of the following potential advantages. In some examples, by monitoring performance according to combinations of events, the described techniques can be used to take into account the concurrence of multiple events (corresponding to multiple criteria/KPIs), thereby improving the efficiency of AI/ML based BM and reducing the occurrence of radio link failure (RLF).

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

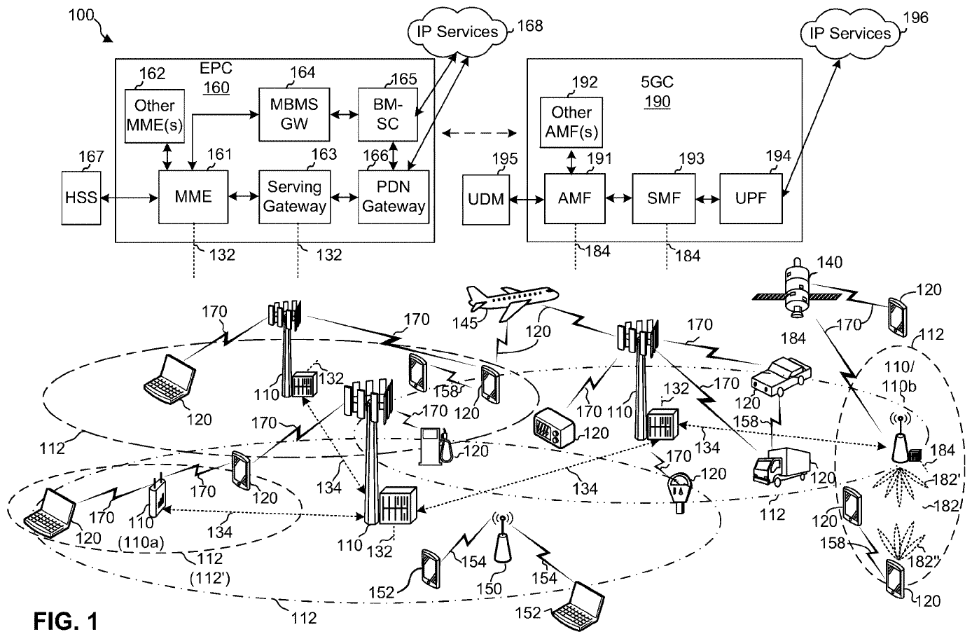

FIG. 1 depicts an example of a wireless communications network 100, in accordance with the present disclosure.

Generally, wireless communications network 100 includes various network entities (alternatively, network elements or network nodes). A network entity is generally a communications device and/or a communications function performed by a communications device (e.g., a UE, a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 110), and non-terrestrial aspects, such as satellite 140 and aircraft 145, which may include network entities on-board (e.g., one or more BSs) capable of communicating with other network elements (e.g., terrestrial BSs) and UEs.

In the depicted example, wireless communications network 100 includes BSs 110, UEs 120, and one or more core networks, such as an Evolved Packet Core (EPC) 160 and 5G Core (5GC) 190, which interoperate to provide communications services over various communications links, including wired and wireless links.

FIG. 1 depicts various example UEs 120, which may include a cellular phone, a smart phone, a session initiation protocol (SIP) phone, a laptop, a personal digital assistant (PDA), a satellite radio, a global positioning system (GPS), a multimedia device, a video device, a digital audio player, a camera, a game console, a tablet, a smart device, a wearable device, a vehicle, an electric meter, a gas pump, a kitchen appliance, a healthcare device, an implant, a sensor/actuator, a display, an internet of things (IOT) device, an always on (AON) device, an edge processing device, or another similar device. A UE 120 may also be referred to as a mobile device, a wireless device, a wireless communication device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, or a handset, among other examples.

BSs 110 may wirelessly communicate with (e.g., transmit signals to or receive signals from) UEs 120 via communications links 170. The communications links 170 between BSs 110 and UEs 120 may carry uplink (UL) (also referred to as reverse link) transmissions from a UE 120 to a BS 110 and/or downlink (DL) (also referred to as forward link) transmissions from a BS 110 to a UE 120. The communications links 170 may use multiple-input and multiple-output (MIMO) antenna technology, including spatial multiplexing, beamforming, and/or transmit diversity in various aspects.

A BS 110 may include, for example, a NodeB, an enhanced NodeB (eNB), a next generation enhanced NodeB (ng-eNB), a next generation NodeB (gNB or gNodeB), an access point, a base transceiver station, a radio base station, a radio transceiver, a transceiver function, a transmission reception point, and/or others. A BS 110 may provide communications coverage for a respective geographic coverage area 112, which may sometimes be referred to as a cell, and which may overlap in some cases (e.g., a small cell provided by a BS 110a may have a coverage area 112′ that overlaps the coverage area 112 of a macro cell). A BS 110 may, for example, provide communications coverage for a macro cell (covering a relatively large geographic area), a pico cell (covering a relatively smaller geographic area, such as a sports stadium), a femto cell (covering a relatively smaller geographic area (e.g., a home)), and/or other types of cells.

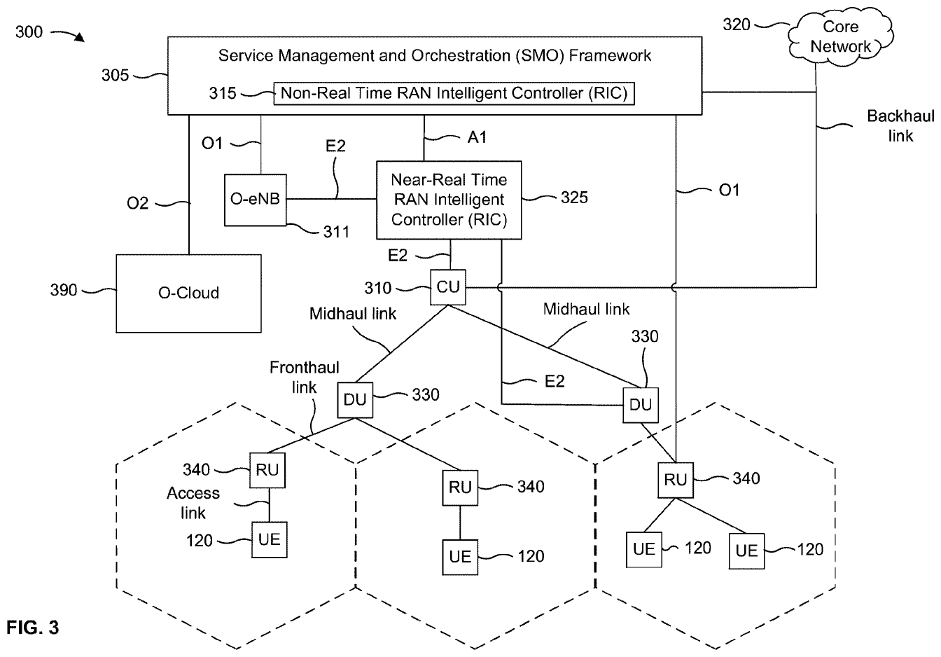

While BSs 110 are depicted in various aspects as unitary communications devices, BSs 110 may be implemented in various configurations. For example, one or more components of a base station may be disaggregated, including a central unit (CU), one or more distributed units (DUs), one or more radio units (RUs), a Near-Real Time (Near-RT) radio access network (RAN) Intelligent Controller (RIC), or a Non-Real Time (Non-RT) RIC, to name a few examples. In another example, various aspects of a base station may be virtualized. More generally, a BS (e.g., BS 110) may include components that are located at a single physical location or components located at various physical locations. In examples in which a BS includes components that are located at various physical locations, the various components may each perform functions such that, collectively, the various components achieve functionality that is similar to a BS that is located at a single physical location. In some aspects, a BS including components that are located at various physical locations may be referred to as having a disaggregated RAN architecture, such as an Open RAN (O-RAN) architecture or a Virtualized RAN (vRAN) architecture. FIG. 3 depicts and describes an example disaggregated BS architecture.

Different BSs 110 within wireless communications network 100 may also be configured to support different radio access technologies, such as 3G, 4G, and/or 5G, among other examples. For example, BSs 110 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 110 configured for 5G (e.g., 5G NR or Next Generation RAN (NG-RAN)) may interface with 5GC 190 through second backhaul links 184. BSs 110 may communicate directly or indirectly (e.g., through the EPC 160 or 5GC 190) with each other over third backhaul links 134 (e.g., X2 interfaces), which may be wired or wireless.

Wireless communications network 100 may subdivide the electromagnetic spectrum into various classes, bands, channels, or other features. In some aspects, the subdivision is based on wavelength and frequency, where frequency may also be referred to as a carrier, a subcarrier, a frequency channel, a tone, or a subband. For example, 3GPP currently defines Frequency Range 1 (FR 1) as including 410 MHz-7125 MHz, which is often referred to (interchangeably) as “Sub-6 GHz”. Similarly, the 3rd Generation Partnership Project (3GPP) currently defines Frequency Range 2 (FR2) as including 24,250 MHz-52,600 MHz, which is sometimes referred to (interchangeably) as a “millimeter wave” (“mmW” or “mmWave”). A base station configured to communicate using mmWave or near mm Wave radio frequency bands (e.g., a mmWave base station such as BS 110b) may utilize beamforming (e.g., as shown by 182) with a UE (e.g., 120) to improve path loss and range.

The communications links 170 between BSs 110 and, for example, UEs 120, may be through one or more carriers, which may have different bandwidths (e.g., 5 MHz, 10 MHz, 15 MHz, 20 MHz, 100 MHz, 400 MHz, and/or other bandwidths), and which may be aggregated in various aspects. Carriers may or may not be adjacent to each other. In some examples, allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., base station 110b in FIG. 1) may utilize beamforming with a UE 120 to improve path loss and range, as shown at 182. For example, BS 110 b and the UE 120 may each include a plurality of antennas, such as antenna elements, antenna panels, and/or antenna arrays to facilitate the beamforming. In some cases, BS 110b may transmit a beamformed signal to UE 120 in one or more transmit directions 182′. UE 120 may receive the beamformed signal from the BS 110b in one or more receive directions 182″. UE 120 may also transmit a beamformed signal to the BS 110b in one or more transmit directions 182″. BS 110b may also receive the beamformed signal from UE 120 in one or more receive directions 182′. BS 110b and UE 120 may then perform beam training to determine the best receive and transmit directions for each of BS 110b and UE 120. Notably, the transmit and receive directions for BS 110b may or may not be the same. Similarly, the transmit and receive directions for UE 120 may or may not be the same.

Wireless communications network 100 further includes a Wi-Fi access point 150 in communication with Wi-Fi stations (STAs) 152 via communications links 154 in, for example, a 2.4 GHz and/or 5 GHz unlicensed frequency spectrum.

Certain UEs 120 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 161, other MMEs 162, a Serving Gateway 163, a Multimedia Broadcast Multicast Service (MBMS) Gateway 164, a Broadcast Multicast Service Center (BM-SC) 165, and/or a Packet Data Network (PDN) Gateway 166, such as in the depicted example. MME 161 may be in communication with a Home Subscriber Server (HSS) 167. MME 161 is a control node that processes the signaling between the UEs 120 and the EPC 160. Generally, MME 161 provides bearer and connection management.

Generally, user Internet protocol (IP) packets are transferred through Serving Gateway 163, which is connected to PDN Gateway 166. PDN Gateway 166 provides UE IP address allocation as well as other functions. PDN Gateway 166 and the BM-SC 165 are connected to IP Services 168, which may include, for example, the Internet, an intranet, an IP Multimedia Subsystem (IMS), a Packet Switched (PS) streaming service, and/or other IP services.

BM-SC 165 may provide functions for MBMS user service provisioning and delivery. BM-SC 165 may serve as an entry point for content provider MBMS transmission, may be used to authorize and initiate MBMS Bearer Services within a public land mobile network (PLMN), and/or may be used to schedule MBMS transmissions. MBMS Gateway 164 may distribute MBMS traffic to the BSs 110 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 191, other AMFs 192, a Session Management Function (SMF) 193, and a User Plane Function (UPF) 194. AMF 191 may be in communication with Unified Data Management (UDM) 195.

AMF 191 is a control node that processes signaling between UEs 120 and 5GC 190. AMF 191 provides, for example, quality of service (QOS) flow and session management.

IP packets are transferred through UPF 194, which is connected to the IP Services 196, and which provides UE IP address allocation as well as other functions for 5GC 190. IP Services 196 may include, for example, the Internet, an intranet, an IMS, a PS streaming service, and/or other IP services.

In various aspects, a network entity or network node can be implemented as an aggregated base station, a disaggregated base station, a component of a base station, an integrated access and backhaul (IAB) node, a relay node, a sidelink node, a transmission reception point (TRP), or a combination thereof, to name a few examples.

As indicated above, FIG. 1 is provided as an example. Other examples may differ from what is described with regard to FIG. 1.

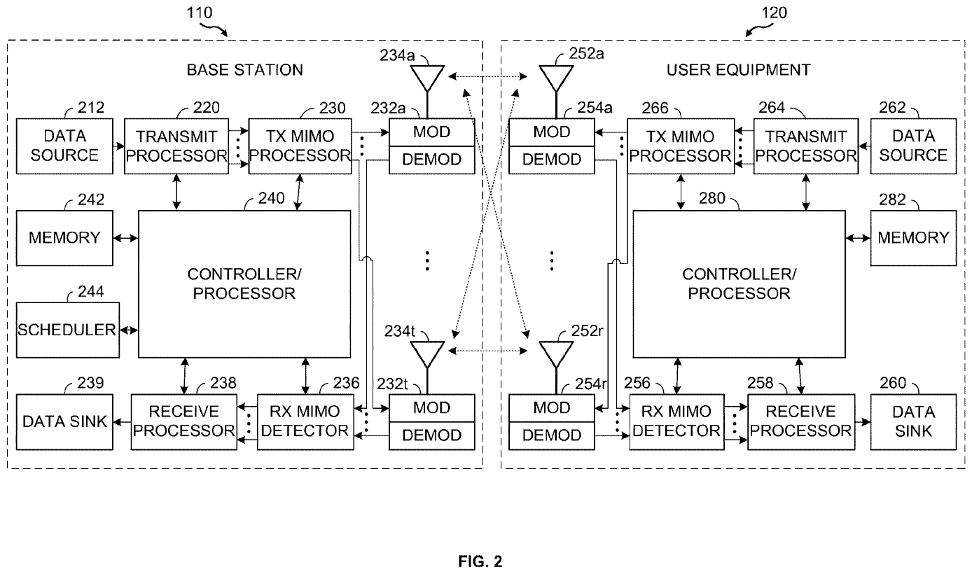

FIG. 2 depicts aspects of an example BS 110 and UE 120, in accordance with the present disclosure.

Generally, BS 110 includes various processors (e.g., 220, 230, 238, and 240), antennas 234a-t (collectively 234), transceivers 232a-t (collectively 232), which include modulators and demodulators, and other aspects, which enable wireless transmission of data (e.g., data source 212) and wireless reception of data (e.g., data sink 239). For example, BS 110 may send and receive data between BS 110 and UE 120. BS 110 includes controller/processor 240, which may be configured to implement various functions described herein related to wireless communications.

Generally, UE 120 includes various processors (e.g., 258, 264, 266, and 280), antennas 252a-r (collectively 252), transceivers 254a-r (collectively 254), which include modulators and demodulators, and other aspects, which enable wireless transmission of data (e.g., retrieved from data source 262) and wireless reception of data (e.g., provided to data sink 260). UE 120 includes controller/processor 280, which may be configured to implement various functions described herein related to wireless communications.

For an example downlink transmission, BS 110 includes a transmit processor 220 that may receive data from a data source 212 and control information from a controller/processor 240. The control information may be for the physical broadcast channel (PBCH), the physical control format indicator channel (PCFICH), the physical hybrid automatic repeat request (HARQ) indicator channel (PHICH), the physical downlink control channel (PDCCH), the group common PDCCH (GC PDCCH), and/or other channels. The data may be for the physical downlink shared channel (PDSCH), in some examples.

Transmit processor 220 may process (e.g., encode and symbol map) the data and control information to obtain data symbols and control symbols, respectively.

Transmit processor 220 may also generate reference symbols, such as for the primary synchronization signal (PSS), the secondary synchronization signal (SSS), the PBCH demodulation reference signal (DMRS), or the channel state information reference signal (CSI-RS).

Transmit (TX) MIMO processor 230 may perform spatial processing (e.g., precoding) on the data symbols, the control symbols, and/or the reference symbols, if applicable, and may provide output symbol streams to the modulators (MODs) in transceivers 232a-232t. Each modulator in transceivers 232a-232t may process a respective output symbol stream to obtain an output sample stream. Each modulator may further process (e.g., convert to analog, amplify, filter, and upconvert) the output sample stream to obtain a downlink signal. Downlink signals from the modulators in transceivers 232a-232t may be transmitted via the antennas 234a-234t, respectively.

UE 120 includes antennas 252a-252r that may receive the downlink signals from the BS 110 and may provide received signals to the demodulators (DEMODs) in transceivers 254a-254r, respectively. Each demodulator in transceivers 254a-254r may condition (e.g., filter, amplify, downconvert, and digitize) a respective received signal to obtain input samples. Each demodulator may further process the input samples to obtain received symbols.

Receive (RX) MIMO detector 256 may obtain received symbols from all the demodulators in transceivers 254a-254r, perform MIMO detection on the received symbols if applicable, and provide detected symbols. Receive processor 258 may process (e.g., demodulate, deinterleave, and decode) the detected symbols, provide decoded data for the UE 120 to a data sink 260, and provide decoded control information to a controller/processor 280.

For an example uplink transmission, UE 120 further includes a transmit processor 264 that may receive and process data (e.g., for the physical uplink shared channel (PUSCH)) from a data source 262 and control information (e.g., for the physical uplink control channel (PUCCH)) from the controller/processor 280. Transmit processor 264 may also generate reference symbols for a reference signal (e.g., for the sounding reference signal (SRS)). The symbols from the transmit processor 264 may be precoded by a TX MIMO processor 266 if applicable, further processed by the modulators in transceivers 254a-254r (e.g., for SC-FDM), and transmitted to BS 110.

At BS 110, the uplink signals from UE 120 may be received by antennas 234a-234t, processed by the demodulators in transceivers 232a-232t, detected by a MIMO detector 236 if applicable, and further processed by a receive processor 238 to obtain decoded data and control information sent by UE 120. Receive processor 238 may provide the decoded data to a data sink 239 and the decoded control information to the controller/processor 240. Memories 242 and 282 may store data and program codes (e.g., processor-executable instructions, computer-executable instructions) for BS 110 and UE 120, respectively. Scheduler 244 may schedule UEs for data transmission on the downlink and/or uplink.

In various aspects, BS 110 may be described as transmitting and receiving various types of data associated with the methods described herein. In these contexts, “transmitting” may refer to various mechanisms of outputting data, such as outputting data from data source 212, scheduler 244, memory 242, transmit processor 220, controller/processor 240, TX MIMO processor 230, transceivers 232a-t, antenna 234a-t, and/or other aspects described herein. Similarly, “receiving” may refer to various mechanisms of obtaining data, such as obtaining data from antennas 234a-t, transceivers 232a-t, RX MIMO detector 236, controller/processor 240, receive processor 238, scheduler 244, memory 242, a network interface, and/or other aspects described herein.

In various aspects, UE 120 may likewise be described as transmitting and receiving various types of data associated with the methods described herein. In these contexts, “transmitting” may refer to various mechanisms of outputting data, such as outputting data from data source 262, memory 282, transmit processor 264, controller/processor 280, TX MIMO processor 266, transceivers 254a-t, antenna 252a-t, and/or other aspects described herein. Similarly, “receiving” may refer to various mechanisms of obtaining data, such as obtaining data from antennas 252a-t, transceivers 254a-t, RX MIMO detector 256, controller/processor 280, receive processor 258, memory 282, and/or other aspects described herein.

In some aspects, a processor may be configured to perform various operations, such as those associated with the methods described herein, and transmit (output) data to or receive (obtain) data from another interface that is configured to transmit or receive, respectively, the data. In some aspects, an individual processor may perform all of the functions described as being performed by the one or more processors. In some aspects, one or more processors may collectively perform a set of functions. For example, a first set of (one or more) processors of the one or more processors may perform a first function described as being performed by the one or more processors, and a second set of (one or more) processors of the one or more processors may perform a second function described as being performed by the one or more processors. The first set of processors and the second set of processors may be the same set of processors or may be different sets of processors. Reference to “one or more processors” should be understood to refer to any one or more of the processors described in connection with FIG. 2. Reference to “one or more memories” should be understood to refer to any one or more memories of a corresponding device, such as the memory described in connection with FIG. 2. For example, functions described as being performed by one or more memories can be performed by the same subset of the one or more memories or different subsets of the one or more memories.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an O-RAN (such as the network configuration sponsored by the O-RAN Alliance), or a vRAN (also known as a cloud RAN (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

FIG. 3 depicts an example disaggregated base station 300 architecture, in accordance with the present disclosure. The disaggregated base station 300 architecture may include one or more CUs 310 that can communicate directly with a core network 320 via a backhaul link, or indirectly with the core network 320 through one or more disaggregated base station units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as an F1 interface. The DUs 330 may communicate with one or more RUs 340 via respective fronthaul links. The RUs 340 may communicate with respective UEs 120 via one or more radio frequency (RF) access links. In some implementations, the UE 120 may be simultaneously served by multiple RUs 340.

Each of the units (e.g., the CUS 310, the DUs 330, the RUs 340, as well as the Near-RT RICs 325, the Non-RT RICs 315 and the SMO Framework 305) may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units.

Additionally or alternatively, the units can include a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like.

Each control function can be implemented with an interface configured to communicate signals with other control functions hosted by the CU 310. The CU 310 may be configured to handle user plane functionality (e.g., Central Unit-User Plane (CU-UP)), control plane functionality (e.g., Central Unit-Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the El interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by 3GPP. In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over-the-air (OTA) communications with one or more UEs 120. In some implementations, real-time and non-real-time aspects of control and user plane communications with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, artificial intelligence/machine learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via O1) or via creation of RAN management policies (such as A1 policies).

As indicated above, FIG. 3 is provided as an example. Other examples may differ from what is described with regard to FIG. 3.

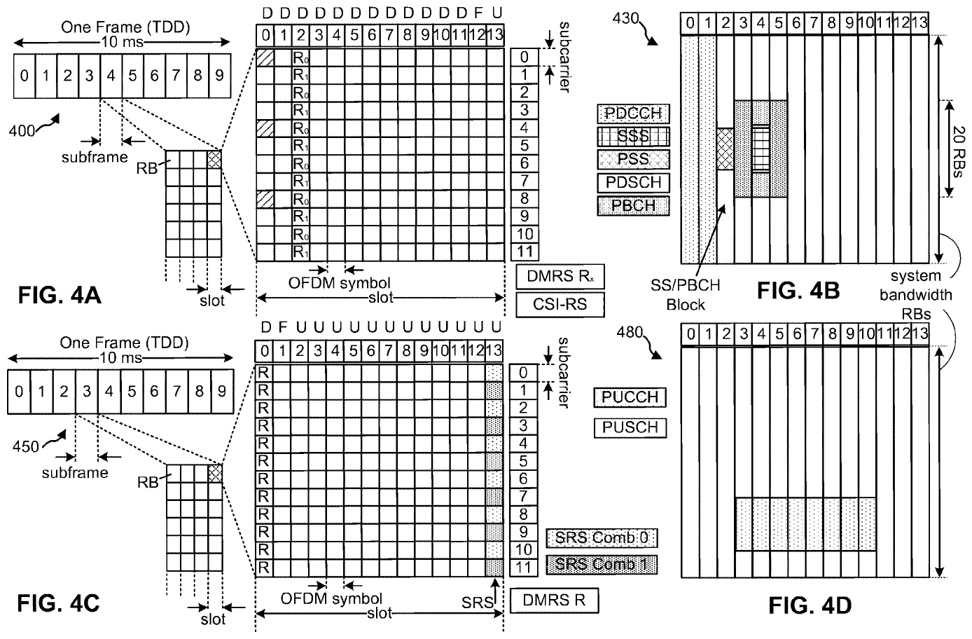

FIGS. 4A, 4B, 4C, and 4D depict aspects of data structures for a wireless communications network, such as wireless communications network 100 of FIG. 1, in accordance with the present disclosure. FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing. OFDM and single-carrier frequency division multiplexing (SC-FDM) partition the system bandwidth (e.g., as depicted in FIGS. 4B and 4D) into multiple orthogonal subcarriers.

Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where D is DL, U is UL, and F is flexible for use between DL/UL. UEs may be configured with a slot format through a received slot format indicator (SFI) (dynamically through DL control information (DCI), or semi-statically/statically through RRC signaling). In the depicted examples, a 10 ms frame is divided into 10 equally sized 1 ms subframes. Each subframe may include one or more time slots. In some examples, each slot may include 7 or 14 symbols, depending on the slot format.

Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (u) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2^{μ} slots/subframe. The subcarrier spacing and symbol length/duration are a function of the numerology. The subcarrier spacing may be equal to 2^{μ}″×15 kHz, where μ is the numerology index, which may be selected from values 0 to 5. Accordingly, the numerology μ=0 has a subcarrier spacing of 15 kHz and the numerology μ=5 has a subcarrier spacing of 480 kHz. Other numerologies and subcarrier spacings may be used. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RSs) for a UE (e.g., UE 120). The RSs may include DMRSs and/or CSI-RSs for channel estimation at the UE. The RSs may also include beam measurement RSs (BRSs), beam refinement RSs (BRRSs), and/or phase tracking RSs (PT-RSs).

FIG. 4B illustrates an example of various DL channels within a subframe of a frame. The PDCCH carries DCI within one or more control channel elements (CCEs), each CCE including, for example, nine RE groups (REGs), each REG including, for example, four consecutive REs in an OFDM symbol.

A PSS may be within symbol 2 of particular subframes of a frame. The PSS is used by a UE (e.g., UE 120) to determine subframe/symbol timing and a physical layer identity.

An SSS may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRSs. The PBCH, which carries a master information block (MIB), may be logically grouped with the PSS and SSS to form a synchronization signal (SS)/PBCH block (also referred to as an SS block (SSB)). The MIB provides a number of RBs in the system bandwidth and a system frame number (SFN). The PDSCH carries user data, broadcast system information not transmitted through the PBCH such as system information blocks (SIBs), and/or paging messages.

As illustrated in FIG. 4C, some of the REs carry DMRSs (indicated as R for one particular configuration, but other DMRS configurations are possible) for channel estimation at the base station. The UE may transmit DMRSs for the PUCCH and DMRSs for the PUSCH. The PUSCH DMRSs may be transmitted, for example, in the first one or two symbols of the PUSCH. The PUCCH DMRSs may be transmitted in different configurations depending on whether short or long PUCCHs are transmitted and depending on the particular PUCCH format used. UE 120 may transmit SRSs. The SRSs may be transmitted, for example, in the last symbol of a subframe. The SRSs may have a comb structure, and a UE may transmit SRSs on one of the combs. The SRSs may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

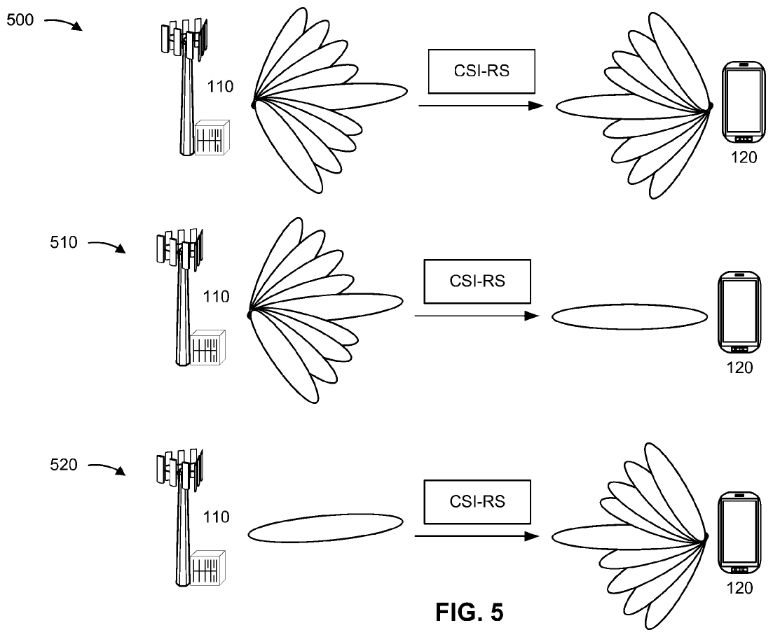

FIG. 5 is a diagram illustrating examples 500, 510, and 520 of CSI-RS beam management procedures, in accordance with the present disclosure. As shown in FIG. 5, examples 500, 510, and 520 include a UE 120 in communication with a base station 110 in a wireless network (e.g., wireless network 100). However, the devices shown in FIG. 5 are provided as examples, and the wireless network may support communication and beam management between other devices (e.g., between a UE 120 and a base station 110 or transmit receive point (TRP), between a mobile termination node and a control node, between an integrated access and backhaul (IAB) child node and an IAB parent node, and/or between a scheduled node and a scheduling node). In some aspects, the UE 120 and the base station 110 may be in a connected state (e.g., an RRC connected state).

As shown in FIG. 5, example 500 may include a base station 110 (e.g., one or more network node devices such as an RU, a DU, and/or a CU, among other examples) and a UE 120 communicating to perform beam management using CSI-RSs. Example 500 depicts a first beam management procedure (e.g., P1 CSI-RS beam management). The first beam management procedure may be referred to as a beam selection procedure, an initial beam acquisition procedure, a beam sweeping procedure, a cell search procedure, and/or a beam search procedure. As shown in FIG. 5 and example 500, CSI-RSs may be configured to be transmitted from the base station 110 to the UE 120. The CSI-RSs may be configured to be periodic (e.g., using RRC signaling), semi-persistent (e.g., using media access control (MAC) control element (MAC-CE) signaling), and/or aperiodic (e.g., using DCI).

The first beam management procedure may include the base station 110 performing beam sweeping over multiple transmit (Tx) beams. The base station 110 may transmit a CSI-RS using each transmit beam for beam management. To enable the UE 120 to perform receive (Rx) beam sweeping, the network node may use a transmit beam to transmit (e.g., with repetitions) each CSI-RS at multiple times within the same RS resource set so that the UE 120 can sweep through receive beams in multiple transmission instances. For example, if the base station 110 has a set of N transmit beams and the UE 120 has a set of M receive beams, the CSI-RS may be transmitted on each of the N transmit beams M times so that the UE 120 may receive M instances of the CSI-RS per transmit beam. In other words, for each transmit beam of the base station 110, the UE 120 may perform beam sweeping through the receive beams of the UE 120. As a result, the first beam management procedure may enable the UE 120 to measure a CSI-RS on different transmit beams using different receive beams to support selection of base station 110 transmit beams/UE 120 receive beam(s) beam pair(s). The UE 120 may report the measurements to the base station 110 to enable the base station 110 to select one or more beam pair(s) for communication between the base station 110 and the UE 120. While example 500 has been described in connection with CSI-RSs, the first beam management process may also use SSBs for beam management in a similar manner as described above.

As shown in FIG. 5, example 510 may include a base station 110 and a UE 120 communicating to perform beam management using CSI-RSs. Example 510 depicts a second beam management procedure (e.g., P2 CSI-RS beam management). The second beam management procedure may be referred to as a beam refinement procedure, a network node beam refinement procedure, a TRP beam refinement procedure, and/or a transmit beam refinement procedure. As shown in FIG. 5 and example 510, CSI-RSs may be configured to be transmitted from the base station 110 to the UE 120. The CSI-RSs may be configured to be aperiodic (e.g., using DCI). The second beam management procedure may include the base station 110 performing beam sweeping over one or more transmit beams. The one or more transmit beams may be a subset of all transmit beams associated with the base station 110 (e.g., determined based at least in part on measurements reported by the UE 120 in connection with the first beam management procedure). The base station 110 may transmit a CSI-RS using each transmit beam of the one or more transmit beams for beam management. The UE 120 may measure each CSI-RS using a single (e.g., a same) receive beam (e.g., determined based at least in part on measurements performed in connection with the first beam management procedure). The second beam management procedure may enable the base station 110 to select a best transmit beam based at least in part on measurements of the CSI-RSs (e.g., measured by the UE 120 using the single receive beam) reported by the UE 120.

As shown in FIG. 5, example 520 depicts a third beam management procedure (e.g., P3 CSI-RS beam management). The third beam management procedure may be referred to as a beam refinement procedure, a UE beam refinement procedure, and/or a receive beam refinement procedure. As shown in FIG. 5 and example 520, one or more CSI-RSs may be configured to be transmitted from the base station 110 to the UE 120. The CSI-RSs may be configured to be aperiodic (e.g., using DCI). The third beam management process may include the base station 110 transmitting the one or more CSI-RSs using a single transmit beam (e.g., determined based at least in part on measurements reported by the UE 120 in connection with the first beam management procedure and/or the second beam management procedure). To enable the UE 120 to perform receive beam sweeping, the network node may use a transmit beam to transmit (e.g., with repetitions) CSI-RS at multiple times within the same RS resource set so that UE 120 can sweep through one or more receive beams in multiple transmission instances. The one or more receive beams may be a subset of all receive beams associated with the UE 120 (e.g., determined based at least in part on measurements performed in connection with the first beam management procedure and/or the second beam management procedure). The third beam management procedure may enable the base station 110 and/or the UE 120 to select a best receive beam based at least in part on reported measurements received from the UE 120 (e.g., of the CSI-RS of the transmit beam using the one or more receive beams).

As indicated above, FIG. 5 is provided as an example of beam management procedures. Other examples of beam management procedures may differ from what is described with respect to FIG. 5. For example, the UE 120 and the base station 110 may perform the third beam management procedure before performing the second beam management procedure, and/or the UE 120 and the base station 110 may perform a similar beam management procedure to select a UE transmit beam.

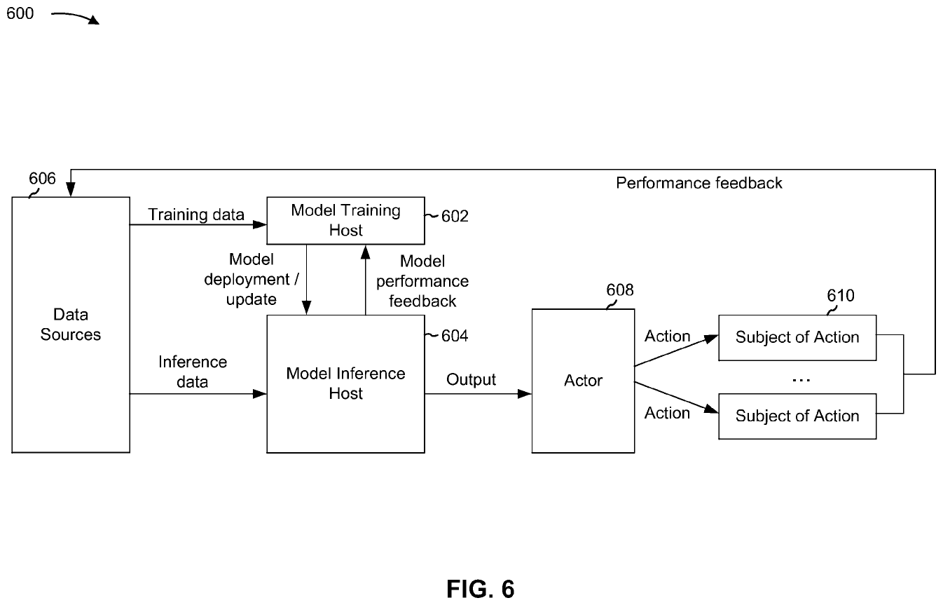

FIG. 6 is a diagram illustrating an example architecture 600 of a functional framework for RAN intelligence enabled by data collection, in accordance with the present disclosure. In some scenarios, the functional framework for RAN intelligence may be enabled by further enhancement of data collection through use cases and/or examples. For example, principles or algorithms for RAN intelligence enabled by AI/ML and the associated functional framework (e.g., the AI functionality and/or the input/output of the component for AI enabled optimization) have been utilized or studied to identify the benefits of AI enabled RAN through possible use cases (e.g., beam management, energy saving, load balancing, mobility management, and/or coverage optimization, among other examples). In one example, as shown by the architecture 600, a functional framework for RAN intelligence may include multiple logical entities, such as a model training host 602, a model inference host 604, data sources 606, and an actor 608.

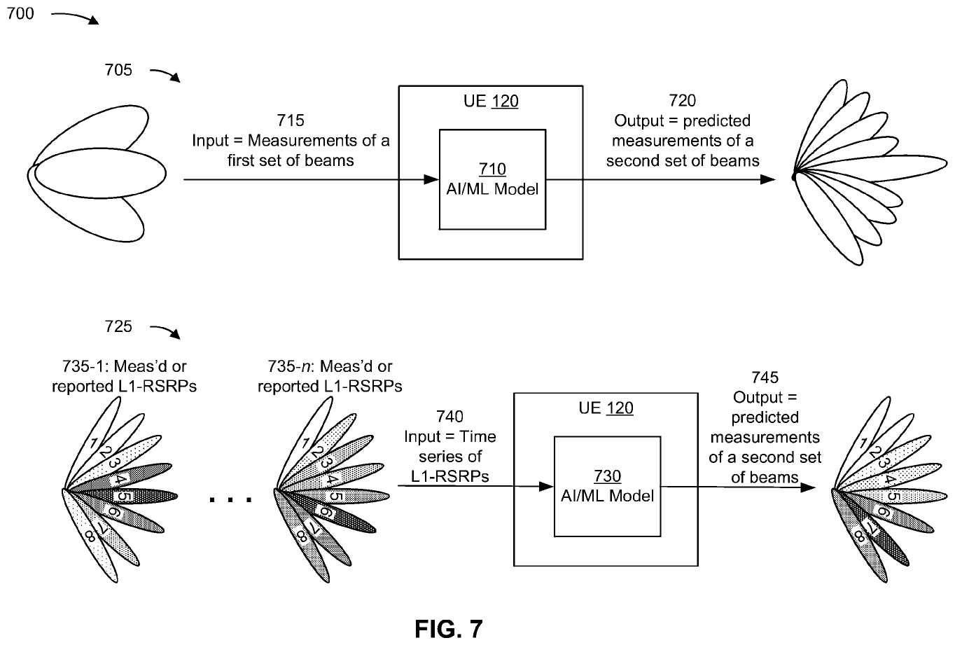

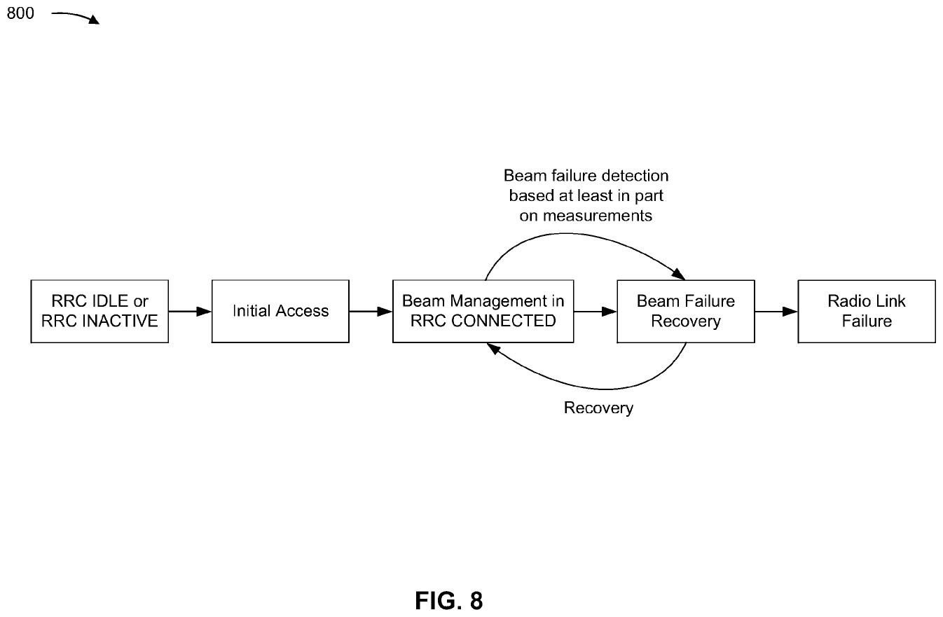

The model inference host 604 may be configured to run an AI/ML model based on inference data provided by the data sources 606, and the model inference host 604 may produce an output (e.g., a prediction) with the inference data input to the actor 608. The actor 608 may be an element or an entity of a core network or a RAN. For example, the actor 608 may be a UE 120, a BS 110 or another network node (e.g., a gNB, a CU, a DU, and/or an RU), among other examples. In addition, the actor 608 may also depend on the type of tasks performed by the model inference host 604, type of inference data provided to the model inference host 604, and/or type of output produced by the model inference host 604. For example, if the output from the model inference host 604 is associated with beam management (such as the AI/ML models described in more detail below in connection with FIGS. 7-8), the actor 608 may be a UE 120, a DU, or an RU, and if the output from the model inference host 604 is associated with transmission and/or reception scheduling, the actor 608 may be a CU or a DU.

After the actor 608 receives an output from the model inference host 604, the actor 608 may determine whether to act based on the output. For example, if the actor 608 is a DU or an RU and the output from the model inference host 604 is associated with beam management, the actor 608 may determine whether to change/modify a transmission and/or reception beam based on the output. If the actor 608 determines to act based on the output, the actor 608 may indicate the action to at least one subject of action 610. For example, if the actor 608 determines to change/modify a transmission and/or reception beam for a communication between the actor 608 and the subject of action 610 (e.g., a UE 120), then the actor 608 may transmit a beam (re-)configuration or a beam switching indication to the subject of action 610. The actor 608 may modify its transmission and/or reception beam based on the beam (re-)configuration, such as switching to a new transmission and/or reception beam or applying different parameters for a transmission and/or reception beam, among other examples. As another example, the actor 608 may be a UE 120 and the output from the model inference host 604 may be associated with beam management. For example, the output may be one or more predicted measurement values for one or more beams. The actor 608 (e.g., a UE 120) may determine that a measurement report (e.g., a Layer 1 (L1) RSRP report) is to be transmitted to a BS 110.

The data sources 606 may also be configured for collecting data that is used as training data for training an ML model or as inference data for feeding an ML model inference operation. For example, the data sources 606 may collect data from one or more core network and/or RAN entities, which may include the subject of action 610, and provide the collected data to the model training host 602 for ML model training.

For example, after a subject of action 610 (e.g., a UE 120) receives a beam configuration from the actor 608, the subject of action 610 may provide performance feedback associated with the beam configuration to the data sources 606, where the performance feedback may be used by the model training host 602 for monitoring or evaluating the ML model performance, such as whether the output (e.g., prediction) provided to the actor 608 is accurate. In some examples, if the output provided by the actor 608 is inaccurate (or the accuracy is below an accuracy threshold), then the model training host 602 may determine to modify or retrain the ML model used by the model inference host, such as via an ML model deployment/update.

As indicated above, FIG. 6 is provided as an example. Other examples may differ from what is described with regard to FIG. 6.

FIG. 7 is a diagram illustrating an example 700 of AI/ML models, in accordance with the present disclosure. As shown in the example indicated by reference number 705 in FIG. 7, an AI/ML model 710 may be deployed at or on a UE 120 for a purpose of spatial domain beam prediction (sometimes referred to as a beam management case 1, or simply “BM-Case1”). For example, a model inference host may be deployed at, or on, a UE 120. The AI/ML model 710 may enable the UE 120 to determine one or more inferences or predictions based on data input to the AI/ML model 710.

For example, as shown by reference number 715, an input to the AI/ML model 710 may include measurements associated with a first set of beams. For example, a BS 110 or a similar network node (e.g., a CU, a DU, an RU, and/or a similar network entity) may transmit one or more signals via respective beams from the first set of beams. The UE 120 may perform measurements (e.g., LI RSRP measurements or other measurements) of the first set of beams or a subset thereof to obtain a first set of measurements (sometimes referred to as channel characteristics). For example, each beam (or else a subset thereof), from the first set of beams, may be associated with one or more measurements performed by the UE 120. The UE 120 may input the first set of measurements (e.g., L1 RSRP measurement values) into the AI/ML model 710 along with information associated with the first set of beams (or a subset thereof), such as a beam direction (e.g., spatial direction), beam width, beam shape, and/or other characteristics of the respective beams from the first set of beams (or subset thereof).

As shown by reference number 720, the AI/ML model 710 may output one or more predictions. The one or more predictions may include predicted measurement values and/or channel characteristics (e.g., predicted L1 RSRP measurement values) associated with a second set of beams. This may reduce a quantity of beam measurements that are performed by the UE 120, thereby conserving power of the UE 120 and/or network resources that would have otherwise been used to measure all beams included in the first set of beams and the second set of beams. This type of prediction may be referred to as a codebook-based spatial domain selection or prediction. The codebook-based spatial-domain (SD) prediction/selection may be associated with an initial access, a secondary cell group (SCG) setup, a serving beam refinement, and/or a link quality (e.g., channel quality indicator (CQI) or precoding matrix indicator (PMI)) and interference adaptation.

As another example, an output of the AI/ML model 710 may include a point-direction, an angle of departure (AoD), and/or an angle of arrival (AoA) of a beam included in the second set of beams (e.g., Set A beams). This type of prediction may be referred to as a non-codebook-based spatial domain selection or prediction. The non-codebook-based prediction/selection may be associated with a serving beam refinement, and/or a link quality (e.g., CQI or PMI) and interference adaptation. As another example, multiple measurement reports or values, collected at different points in time, may be input to the AI/ML model 710. This may enable the AI/ML model 710 to output codebook-based and/or non-codebook-based predictions for a measurement value, an AoD, and/or an AoA, among other examples, of a beam at a future time. The output(s) of the AI/ML model 710, as described herein, may facilitate initial access procedures, secondary cell group (SCG) setup procedures, beam refinement procedures (e.g., a P2 beam management procedure or a P3 beam management procedure as described above in connection with FIG. 7), link quality or interference adaptation procedures, beam failure and/or beam blockage predictions, and/or radio link failure predictions, among other examples.

In some examples, beam measurement predictions may be performed by a UE (e.g., as depicted in FIG. 7) and/or by a BS 110 or a similar network node (e.g., a CU, a DU, an RU, and/or a similar network entity) in a similar manner as described above. For example, a network node may receive one or more measurements (e.g., performed by a UE 120) and may use an AI/ML model 710 to predict one or more measurements (e.g., of other beams) based at least in part on the one or more measurements performed by the UE 120. For example, predictions may be performed by a network node because the network node may have more processing resources and/or a greater processing capability than a UE 120. Additionally, the network node may have access to historical measurement reports and/or measurement reports from other UEs that may be used as inputs to the AI/ML model 710 (e.g., which may improve an accuracy of an output of the AI/ML model 710). Predictions may be performed by the UE 120 because the UE 120 may have access to filtered measurements of all beams (e.g., not all measurements may be reported to the network node). Additionally, the UE 120 may have information related to the receive beam(s) used to derive or perform the measurements (e.g., which may be a useful input for the AI/ML model 710). As another example, the measurement information at the UE 120 may be “raw” or non-quantized, thereby providing more information that can be input into the AI/ML model 710. Further, the UE 120 may have knowledge of an orientation or a rotational position of the UE 120.

In some examples, the first set of beams (e.g., that are measured) may be referred to as Set B beams and the second set of beams (e.g., that are associated with predicted measurements) may be referred to as Set A beams. Put another way, Set B beams may be a set of beams for which measurements are taken as inputs of the AI/ML model 710, and Set A beams may be a set of beams for which the AI/ML model 710 performs predictions. In some examples, the first set of beams (e.g., the Set B beams) may be a subset of the second set of beams (e.g., the Set A beams). In some other examples, the first set of beams and the second set of beams may be different beams and/or may be mutually exclusive sets. For example, the first set of beams (e.g., the Set B beams) may include wide beams (e.g., unrefined beams or beams having a beam width that satisfies a first threshold) and the second set of beams (e.g., the Set A beams) may include narrow beams (e.g., refined beams or beams having a beam width that satisfies a second threshold). In one example, the AI/ML model 710 may perform spatial-domain downlink beam predictions for beams included in the Set A beams based on measurement results of beams included in the Set B beams. As another example, the AI/ML model 710 may perform temporal downlink beam prediction for beams included in the Set A beams based on historic measurement results of beams included in the Set B beams.

More particularly, as shown in the example indicated by reference number 725 in FIG. 7, an AI/ML model 730 may be deployed at or on a UE 120 for a purpose of temporal domain beam prediction (sometimes referred to as a beam management case 2, or simply “BM-Case2”). The AI/ML model 730 may enable the UE 120 to determine one or more inferences or predictions based on data input to the AI/ML model 730.

Moreover, although the AI/ML model 730 is shown and described as being located at a UE 120, in some other examples the AI/ML model 730 may be located at another network node (e.g., a BS 110, a CU, a DU, an RU, and/or a similar network entity). In that regard, one or more of the operations described below as being performed by the UE 120 may alternatively be performed by a network node. The joint time-domain (TD) beam prediction may be associated with a serving beam refinement, a link quality (e.g., CQI or PMI) and interference adaptation, a beam failure/blockage prediction, and/or an RLF prediction.

The network node and/or the UE may perform an AI/ML based SD and TD beam prediction/selection. When SD and TD beam prediction/selection is implemented, a plurality of UE reports or measurements (e.g., channel or L1-RSRP measurements reported by the UE or measured by the UE) over a period of time (e.g., in a time series) may be provided as an input to an AI/ML model. The AI/ML model may produce an output associated with a codebook-based SD and TD beam prediction. The AI/ML model may produce an output associated with a non-codebook-based SD and TD point direction, AoD, and/or AoA prediction. The codebook-based SD and TD beam prediction and the non-codebook-based SD and TD point direction, AoD, and/or AoA prediction may be associated with a joint SD and TD beam prediction. The joint SD and TD beam prediction may be associated with a serving beam refinement, a link quality (e.g., CQI or PMI) and interference adaptation, a beam failure/blockage prediction, and/or an RLF prediction.

In some cases, for temporal beam prediction, a UE 120 may measure a first set of beams (e.g., Set B beams) over time. The UE 120 may predict, using the AI/ML model 730, measurements associated with a second set of beams (e.g., Set A beams) based at least in part on a time series of measurements of the first set of beams. For temporal beam prediction, Set B and Set A may include the same beams (e.g., Set B and Set A may be the same), the beams included in Set B may be a subset of the beams included in Set A, or else the beams included in Set B may be different beams than the beams included in Set A (e.g., Set B may not be a subset of Set A).

As shown by reference number 735, the UE 120 may perform a set of beam measurements or else receive a set of reported beam measurements for the Set B beams over time. For example, at a first time, the UE 120 may perform set of beam measurements (e.g., L1-RSRP measurements), as indicated by reference number 735-1. The UE 120 may perform and/or receive additional measurements for the Set B beams over time, up to an nth time, as shown by reference number 735-n. As shown by reference number 740, a time series of the measurements (e.g., L1-RSRP measurements) associated with the Set B beams may be used as input to the AI/ML model 730. As shown by reference number 745, the AI/ML model 730 may output one or more predictions. The one or more predictions may include predicted measurement values and/or channel characteristics (e.g., predicted L1 RSRP measurement values) associated with a second set of beams (e.g., the Set A beams).

In some examples, a network device may perform a monitoring procedure associated with an AI/ML model, such as one of the AI/ML models 710, 730 described above or a similar AI/ML model. For example, the network device (e.g., a UE 120, a network node, or a similar network device) may monitor a performance of an AI/ML model, such as for purposes of model activation (e.g., determining whether an AI/ML model is to be activated at a network device), model deactivation (e.g., determining whether an AI/ML model is to be deactivated at a network device), model selection (e.g., determining which AI/ML model, of multiple candidate AI/ML models, is to be used by a network device), model switching (e.g., determining whether a network device is to switch from a first AI/ML model to a second AI/ML model), beam management fallback (e.g., determining whether a network device should revert to a non-AI/ML beam management procedure, such as one or more of the beam management procedures described above in connection with FIG. 7), model updating (e.g., determining whether an AI/ML model is to be updated and/or re-trained), or a similar purpose. In some cases, a monitoring procedure associated with an AI/ML model may be based at least in part on certain metrics and/or KPIs. For example, a monitoring procedure may be based at least in part on inference accuracy, in which case metrics related to intermediate KPIs may be used for the monitoring procedure. In some other examples, a monitoring procedure may be based at least in part on system accuracy, in which case metrics related to system performance KPIs may be used for the monitoring procedure. In some other examples, a monitoring procedure may be based at least in part on data distribution, which may include an input-based monitoring procedure (e.g., monitoring the validity of AI/ML model input, such as by using one or more of out-of-distribution detection techniques, drift detection of input data, signal-to-noise ratio (SNR) based techniques, delay-spread based techniques, or similar techniques) or an output-based monitoring procedure (e.g., monitoring the validity of AI/ML model output, such as by using a drift detection of output data technique). In some other examples, monitoring procedure may be based at least in part on another applicable condition or parameter.

In some cases, a monitoring procedure may be performed by a UE 120, a network node (e.g., a BS 110, a CU, a DU, an RU, and/or a similar network entity), or a combination of a UE 120 and a network node, among other network devices and/or combinations of network devices. For example, for BM-Casel and BM-Case 2 with a UE-side model (as described above in connection with reference numbers 705 and 725), a UE 120 may monitor performance metrics and make a monitoring decision (e.g., make a decision of AI/ML model selection, activation, deactivation, switching, and/or fallback operation) (which is sometimes referred to as UE-side model monitoring), a network node may monitor performance metrics and make a monitoring decision (which is sometimes referred to as network-side model monitoring), or a UE may monitor performance metrics and a network node may make a monitoring decision (which is sometimes referred to as hybrid model monitoring). In order for the UE 120 and/or the network node to monitor performance metrics and/or make a monitoring decision, the network node may periodically transmit, to the UE 120, dedicated downlink reference signals (sometimes referred to as auxiliary reference signals). The UE 120 may perform measurements on the dedicated downlink reference signals and compare the measurements to predicted measurements determined using an AI/ML model (e.g., the AI/ML model 710 and/or the AI/ML model 730) to identify whether the AI/ML model is accurately predicting measurements (which is sometimes referred to as periodic performance monitoring).

For example, in aspects in which an AI/ML model is associated with spatial beam prediction (such as the described above in connection with the AI/ML model 710) in which wide beams are used to predict narrow beams (as described above in connection with example shown by reference number 705) or else a subset of Set A beams are used to predicted measurements associated with a full set of Set A beams, a network node may transmit, to a UE 120, a full set of Set A beams every X milliseconds (ms) (e.g., every 500 ms) for a purpose of periodic performance monitoring. The UE 120 may measure the full set of Set A beams and compare the measurements to the predicted beam measurements generated as output of the AI/ML model 710 in order to identify whether the AI/ML model 710 is accurately predicting measurements.

Similarly, in aspects in which an AI/ML model is associated with temporal beam prediction (such as the described above in connection with the AI/ML model 730), a network node may transmit, to a UE 120, a full set of Set A beams every X ms (e.g., every 500 ms) for a purpose of periodic performance monitoring. The UE 120 may measure the full set of Set A beams and compare the measurements to the predicted beam measurements generated as output of the AI/ML model 730 in order to identify whether the AI/ML model 730 is accurately predicting measurements.

In some examples, a periodicity of transmission of dedicated downlink reference signals (e.g., X in the above described examples, which is sometimes referred to as a performance monitoring periodicity), may depend on one or more factors associated with the UE 120, such as a UE 120 mobility status, a UE 120 location (e.g., a location of the UE 120 within a cell, such as whether the UE 120 is near a cell edge, a cell center, or the like), or similar factors. Moreover, in some examples, for periodic performance monitoring, a configuration of dedicated downlink reference signals may be done a priori (e.g., via an RRC configuration message) without using dynamic signaling to activate reference signal resources (e.g., CSI-RS resources), thus saving overhead.

In that way, multiple UEs 120 using AI/ML models may independently perform independent periodic performance monitoring of respective AI/ML models using dedicated downlink reference signals transmitted by a network node to each UE 120, and each UE 120 may thus make an independent monitoring decision about a respective AI/ML model. This may require high signaling overhead because the network node may periodically transmit dedicated downlink reference signals to each UE 120. Transmitting multiple instances of periodically reoccurring dedicated downlink reference signals (e.g., multiples set of dedicated downlink reference signals, one set to each UE using an AI/ML model) may result in high signaling overhead, crowded communication channels, decreased network throughput, increased network latency, and overall inefficient usage of network resources.

For an AI/ML-based beam management, a first case of beam management and a second case of beam management may be supported for characterization and baseline performance evaluations. In the first case, an SD downlink beam prediction for a Set A of beams may be based at least in part on measurement results of a Set B of beams. In the second case, a temporal downlink beam prediction for a Set A of beams may be based at least in part on historic measurement results of a Set B of beams. Thus, Set A may correspond to an output of the ML model, and Set B may correspond to an input of the model.

For the first case and the second case, a first alternative and a second alternative may be defined. In the first alternative, beams in Set A and beams in Set B may be in the same frequency range. With respect to the first case, the beams in Set B may be a subset of the beams in Set A. A quantity of beams in Set A and a quantity of beams in Set B may be defined. The beams in Set B may be determined from the beams in Set A based at least in part on a fixed pattern or a random pattern. In the second alternative, the beams in Set A may be different than the beams in Set B (e.g., the beams in set B may not be a subset of the beams in Set A). For example, the beams in Set A may be associated with narrow beams, and the beams in Set B may be associated with wide beams. A quantity of beams in Set A and a quantity of beams in Set B may be defined. A quasi-co-location (QCL) relation may be defined between beams in Set A and beams in Set B. With respect to the first alternative and the second alternative, Set A may be associated with a downlink beam prediction and Set B may be associated with a downlink beam measurement. A codebook construction for Set A and a codebook construction for Set B may be defined.

AI/ML based beam management may be managed according to a lifecycle management (LCM) methodology. An LCM methodology may generally define how the network manages AI/ML based beam management, such as by identifying the specific AI/ML models or functions supported by a UE, and controlling (e.g., activating, deactivating, and/or monitoring) these AI/ML models or functions.

One example of an LCM methodology is functionality-based LCM. In functionality-based LCM, a network node may be aware of particular AI/ML functionality at the UE through UE capability reporting. The network node may control (e.g., activate, deactivate, or monitor the performance of) particular AI/ML functions. An AI/ML function can include, for example, wide-to-narrow beam prediction, narrow-to-narrow beam prediction, a prediction using a fixed set of beams for measurement, a prediction using a variable set of beams for measurement, and/or a prediction using assistance information and/or additional reference signals to improve the quality of beam prediction. For each of these AI/ML functions, the UE may implement one or more AI/ML models, which may be transparent to the network.

Another example of an LCM methodology is model identifier (ID) based LCM. In model ID based LCM, particular AI/ML models are registered at the network using model identifiers. The network may be made aware of AI/ML functionality and supported model IDs via UE capability reporting. During an inference phase (e.g., applying models), the network may control AI/ML model inference, including selecting models, activating models, deactivating models, switching between models, falling back from one model to another model, and monitoring models.

As indicated above, FIG. 7 is provided as an example. Other examples may differ from what is described with regard to FIG. 7.

FIG. 8 is a diagram illustrating an example 800 of beam management, in accordance with the present disclosure.

As shown in FIG. 8, a UE may initially be in an RRC idle state or an RRC inactivate state. The UE may perform an initial access and may perform beam management after entering an RRC connected state as a result of the initial access. The beam management may include P1, P2, and/or P3 beam management procedures, as described herein. The UE may also perform beam management using an AI/ML-based approach. The UE may perform a beam failure detection (BFD), and the UE may perform a beam failure recovery (BFR) based at least in part on the BFD. When the BFR is not successful, the UE may declare a radio link failure (RLF).

As indicated above, FIG. 8 is provided as an example. Other examples may differ from what is described with regard to FIG. 8.

As mentioned, a network entity or a UE may perform performance monitoring for a UE-side AI/ML model. Performance monitoring can be network-side (in which a network entity performs performance monitoring), UE-side (in which a UE performs performance monitoring), or hybrid (in which the UE and the network entity collaboratively determine performance of an AI/ML model). As also mentioned, a UE or network entity may perform performance monitoring according to certain KPIs. In the case of hybrid performance monitoring, a UE may report information to a network entity based on a criterion corresponding to a KPI, such as for AI/ML based BM.

However, a single KPI/criterion may provide inaccurate or incomplete information regarding performance of an AI/ML model (such as a functionality-based LCM model). For example, a beam prediction accuracy KPI/criterion may seem to indicate that performance of an AI/ML model for beam prediction is unsatisfactory, but another KPI/criterion (such as a throughput or an L1-RSRP) may indicate that communication performance at the UE is satisfactory in spite of the beam prediction accuracy KPI.

Therefore, performance monitoring according to a single KPI (such as reporting according to a single KPI at the UE, or performing LCM operations such as deactivating AI/ML functionality according to a single KPI at the network entity) may lead to inefficient AI/ML based BM, thereby leading to RLF.

Various aspects relate generally to hybrid performance monitoring for AI/ML based BM. Some aspects more specifically relate to performance monitoring according to a combination of criteria. In some examples, a UE may transmit a report indicating that a set of events, associated with a respective set of criteria, have occurred. The set of events may be associated with AI/ML model monitoring. In some examples, the set of events may include multiple events, such that the UE transmits the reports upon a combination of events occurring. In some other examples, the set of events may include a single event (e.g., the UE may report individual events as the events occur), and the network entity may perform an LCM operation according to a combination of reported events.

Particular aspects of the subject matter described in this disclosure can be implemented to realize one or more of the following potential advantages. In some examples, by monitoring performance according to combinations of events, the described techniques can be used to take into account the concurrence of multiple events (corresponding to multiple criteria/KPIs), thereby improving the efficiency of AI/ML based BM and reducing the occurrence of RLF.

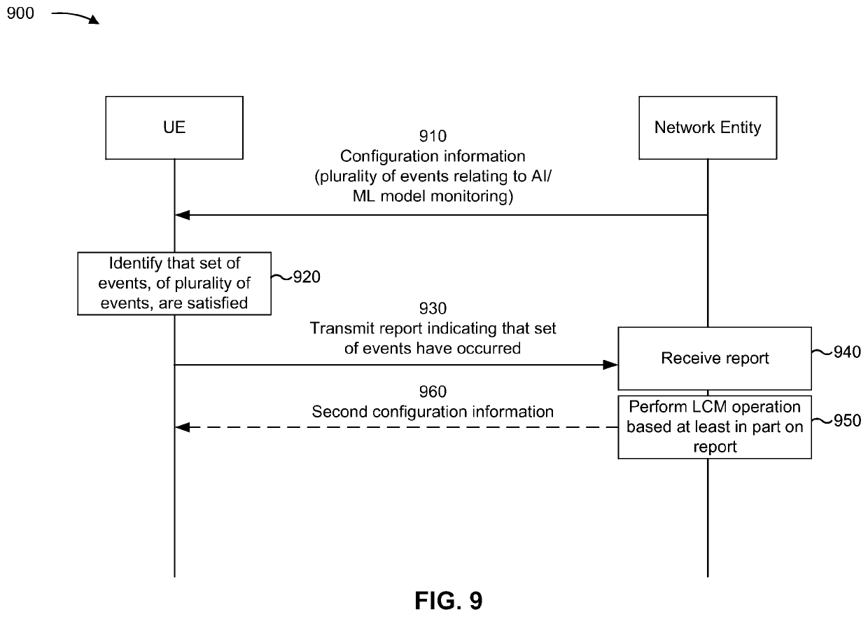

FIG. 9 is a diagram illustrating an example 900 of signaling for hybrid performance monitoring using a combination of events, in accordance with the present disclosure. Example 900 includes a UE (e.g., UE 120) and a network entity (e.g., BS 110 or a component of a disaggregated BS as described with regard to FIG. 3).

As shown by reference number 910, the network entity may transmit, and the UE may receive, configuration information. For example, the network entity may transmit the configuration information via RRC signaling, medium access control signaling, downlink control information, a combination thereof, or a different form of signaling. In some aspects, the configuration information may include a single RRC message. In some other aspects, the configuration information may include multiple RRC messages, which may, for example, be transmitted at different times.

The configuration information may indicate a plurality of events. An event may correspond to a criterion. Upon determining that a criterion corresponding to an event is satisfied, the UE may transmit a report indicating that the event has occurred.

Criteria are described in more detail below. Thus, the network entity may configure the UE with certain events based on different KPIs. In some aspects, the plurality of events (or the configuration information) may be associated with AI/ML model monitoring, such as hybrid AI/ML performance monitoring. For example, the plurality of events may be defined according to criteria that relate to performance of an AI/ML model or communication performance of a UE using an AI/ML model. As another example, the configuration information may indicate a configuration of events or criteria relating to performance monitoring of an AI/ML model.

In some aspects, the plurality of events may include a first event (e.g., Event A) associated with a beam prediction accuracy. For example, the first event may correspond to a first criterion relating to beam prediction accuracy. In this example, if a beam prediction accuracy KPI (e.g., for a top K beams, or for a top beam) is lower than a configured threshold for more than a configured threshold number of instances during a time window, the first criterion may be satisfied, indicating that the first event has occurred. In this example, a start of the time window may correspond to a first failure instance, and a length of the time window may be configured. In some aspects, the first event or the first criterion may be based at least in part on a beam failure detection mechanism.

In some aspects, the plurality of events may include a second event (e.g., Event B) associated with a link quality. For example, the second event may correspond to a second criterion relating to the link quality, such as a second criterion including an L1-RSRP threshold or a throughput criterion. In this example, if a link quality KPI (e.g., L1-RSRP or throughput) is lower than a configured threshold for longer than a configured threshold time duration, the second criterion may be satisfied, indicating that the second event has occurred.

In some aspects, the plurality of events may include a third event (e.g., Event C) associated with an input or output data distribution. For example, the third event may correspond to a third criterion relating to an AI/ML input distribution or output distribution during interference. In this example, if a data distribution KPI (e.g., input data distribution or output data distribution) during inference does not satisfy a configured criterion compared to an input data distribution or output data distribution of training data (corresponding to an out-of-distribution detection), the third criterion may be satisfied, indicating that the third event has occurred.

In some aspects, the plurality of events may include a fourth event (e.g., Event D) associated with comparing a measured value and a predicted value. For example, the fourth event may correspond to a fourth criterion relating to comparing the measured value and the predicted value, such as a fourth criterion including a threshold for comparing a measured value and a predicted value. In this example, if a comparison KPI (obtained by comparing a predicted L1-RSRP and a measured L1-RSRP) is larger than a threshold for more than a threshold number of times during a time window, the fourth criterion may be satisfied, indicating that the fourth event has occurred.

In some aspects, the configuration information may indicate to transmit a report in accordance with a single event occurring. For example, upon determining that a single criterion corresponding to the single event is satisfied, the UE may transmit a report indicating that the single event has occurred. The UE may report the occurrence of events as the events occur. Reporting of the occurrence of single events may reduce a processing burden at the UE, relative to reporting combinations of events occurring.

In this example, the network entity may determine that a combination of events has occurred upon receiving individual reports corresponding to a set of events of the plurality of events. In some aspects, the network entity may configure the UE to report the occurrence of a failure event that is based on one or more events (e.g., Event A, Event B, Event C, Event D) without specifying the details of the failure event. For example, the network entity may configure the UE to report a failure event if any of Events A, B, C, or D occurs, or if a combination of events happens (as described below).

In some aspects, the configuration information may indicate to transmit a report in accordance with a combination of events (including multiple events) occurring at the UE (e.g., in accordance with the UE determining that the combination of events has occurred). The combination of events may include any combination of events A, B, C, or D, and/or other events. The combination of events can include two or more events. In some aspects, the combination of events may include two or more specific events (as just two examples, Event A and Event B, or Event A and Event D). In some aspects, the combination of events may include any two or more events of the plurality of events. In some aspects, the combination of events may be referred to as a failure event. For example, the UE may transmit a report upon determining that the failure event has occurred, and the failure event may occur when the combination of events has occurred (e.g., within a time window). Reporting of the occurrence of the combination of events may reduce a processing burden at the network entity, relative to the network entity identifying a combination of events according to reporting of individual events.

In some aspects, the configuration information may indicate one or more dedicated reference signals, such as a dedicated downlink reference signal. For example, the configuration information may indicate one or more dedicated reference signals corresponding to one or more events. A dedicated reference signal may correspond to an event if a measurement on the dedicated reference signal is used to determine if a criterion corresponding to the event is satisfied. For example, a link quality event may be configured with a downlink reference signal used to perform an L1-RSRP measurement to determine whether a criterion associated with the link quality event is satisfied. Thus, the UE may determine whether a set of events has occurred by identifying that one or more criteria are satisfied according to one or more measurements of one or more dedicated reference signals.

As shown by reference number 920, the UE may identify that a set of events of the plurality of events have occurred. For example, the UE may identify that one or more criteria corresponding to the set of events are satisfied during a monitoring phase. The UE may identify that the set of events have occurred according to one or more criteria, of a plurality of criteria, corresponding to the set of events. For example, if the set of events includes a first event and a second event, the UE may identify that a first criterion of the first event and a second criterion of the second event are satisfied (e.g., within a threshold length of time). Thus, the UE may identify that an event has occurred according to a criterion corresponding to the event.

As shown by reference number 930, the UE may transmit a report indicating that the set of events have occurred. For example, the report may indicate the set of events. As another example, the report may indicate a failure event (e.g., that one or more events have occurred). In some aspects, the UE may transmit the report via uplink control information. In some aspects, the UE may transmit the report via MAC signaling (e.g., a MAC control element). In some aspects, the UE may transmit multiple reports (e.g., upon determining that multiple events have occurred). As shown by reference number 940, the network entity may receive the report.

As shown by reference number 950, the network entity may perform an LCM operation based at least in part on the report. For example, the network entity may activate, deactivate, or modify an AI/ML model (or usage of the AI/ML model) based at least in part on the report. In this example, the network entity may deactivate the AI/ML model if the set of events indicates that performance of the AI/ML model is lower than a threshold. As another example, as shown by reference number 960, the network entity may update a configuration of the performance monitoring. For example, the network entity may transmit second configuration information updating at least one of an event of the plurality of events (e.g., activating or deactivating an event, de-configuring an event, adding a new event, changing a combination of events) or a criterion of the plurality of criteria (e.g., modifying a threshold associated with the criterion, a time window associated with the criterion, a number of instances associated with the criterion, etc.).

As indicated above, FIG. 9 is provided as an example. Other examples may differ from what is described with regard to FIG. 9.

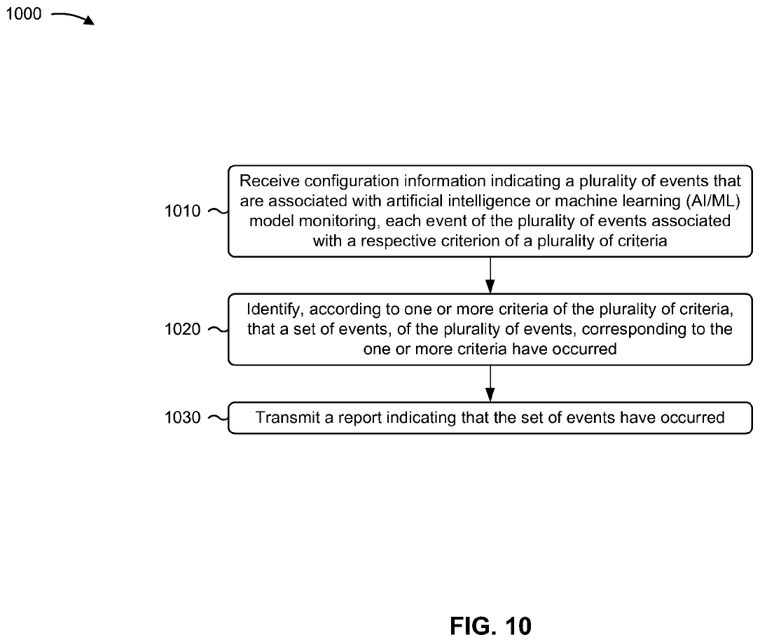

FIG. 10 is a flowchart of an example method 1000 of wireless communication. The method 1000 may be performed by, for example, a UE (e.g., UE 120).

Method 1000 begins at 1010 with receiving configuration information indicating a plurality of events that are associated with AI/ML model monitoring, each event of the plurality of events associated with a respective criterion of a plurality of criteria. For example, the UE may receive configuration information indicating a plurality of events that are associated with AI/ML model monitoring (e.g., performance monitoring). Each event of the plurality of events may be associated with a respective criterion of a plurality of criteria, as described above in connection with, for example, FIG. 9 and at 910.

Method 1000 then proceeds at 1020 with identifying, according to one or more criteria of the plurality of criteria, that a set of events, of the plurality of events, corresponding to the one or more criteria have occurred. For example, the UE may identify, according to one or more criteria of the plurality of criteria, that a set of events, of the plurality of events, corresponding to the one or more criteria have occurred, as described above in connection with, for example, FIG. 9 and at 920.

Method 1000 then proceeds at 1030 with transmitting a report indicating that the set of events have occurred. For example, the UE may transmit a report indicating that the set of events have occurred, as described above in connection with, for example, FIG. 9 and at 930.

In some aspects, the configuration information indicates to transmit the report in accordance with a single event, of the plurality of events, occurring, wherein the set of events includes only the single event, and wherein transmitting the report further comprises transmitting the report in accordance with the single event occurring.

In some aspects, the configuration information indicates to transmit the report in accordance with a combination of events, of the plurality of events, occurring, wherein the set of events includes the combination of events, and wherein transmitting the report further comprises transmitting the report in accordance with the combination of events occurring.

In some aspects, the combination of events includes a first event associated with a beam prediction accuracy and a second event associated with a link quality.

In some aspects, the configuration information indicates one or more dedicated reference signals corresponding to one or more events of the plurality of events, wherein identifying that the set of events has occurred further comprises identifying that the one or more criteria are satisfied according to one or more measurements of the one or more dedicated reference signals.

In some aspects, transmitting the report further comprises transmitting the report via uplink control information or medium access control signaling.

In some aspects, the plurality of events includes at least one of a first event associated with a beam prediction accuracy, a second event associated with a link quality, a third event associated with an input or output data distribution, or a fourth event associated with comparing a measured value and a predicted value.

In some aspects, the configuration information is first configuration information and method 1000 includes receiving second configuration information that updates at least one of an event of the plurality of events or a criterion of the plurality of criteria.

In some aspects, method 1000 includes receiving an indication to activate, deactivate, or modify an AI/ML model.

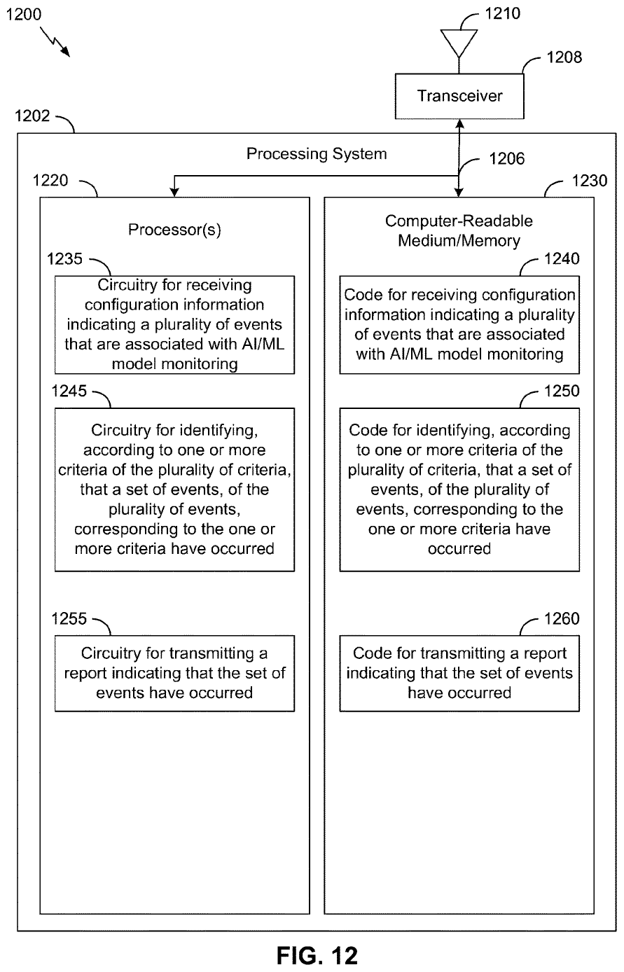

In one aspect, method 1000, or any aspect related to it, may be performed by an apparatus, such as communications device 1200 of FIG. 12, which includes various components operable, configured, or adapted to perform the method 1000. Communications device 1200 is described below in further detail.

Although FIG. 10 shows example blocks of method 1000, in some aspects, method 1000 may include additional blocks, fewer blocks, different blocks, or differently arranged blocks than those depicted in FIG. 10. Additionally, or alternatively, two or more of the blocks of method 1000 may be performed in parallel.

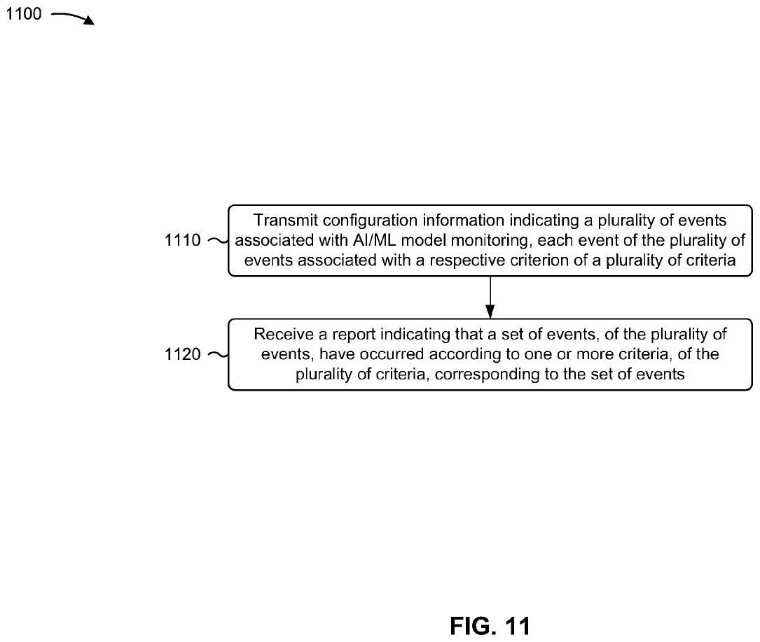

FIG. 11 is a flowchart of an example method 1100 of wireless communication. The method 1100 may be performed by, for example, a network entity (e.g., BS 110 or a component of a disaggregated BS described with regard to FIG. 3).

Method 1100 begins at 1110 with transmitting configuration information indicating a plurality of events associated with AI/ML model monitoring, each event of the plurality of events associated with a respective criterion of a plurality of criteria.

For example, the network entity may transmit configuration information indicating a plurality of events associated with AI/ML model monitoring, each event of the plurality of events associated with a respective criterion of a plurality of criteria, as described above in connection with, for example, FIG. 9 and at 910.

Method 1100 then proceeds at 1120 with receiving a report indicating that a set of events, of the plurality of events, have occurred according to one or more criteria, of the plurality of criteria, corresponding to the set of events. For example, the network entity may receive a report indicating that a set of events, of the plurality of events, have occurred according to one or more criteria, of the plurality of criteria, corresponding to the set of events, as described above in connection with, for example, FIG. 9 and at 940.

In some aspects, method 1100 includes transmitting an indication to activate, deactivate, or modify an AI/ML model in accordance with the report.

In some aspects, transmitting the indication is based at least in part on multiple reports, including the report, relating to multiple events of the plurality of events.

In some aspects, each report, of the multiple reports, relates to a respective single event of the multiple events.

In some aspects, transmitting the indication is based at least in part on the report relating to a combination of events of the plurality of events.

In some aspects, the configuration information indicates to transmit the report in accordance with a single event of the plurality of events occurring, wherein the set of events includes only the single event, and wherein receiving the report further comprises receiving the report in accordance with the single event occurring.

In some aspects, the configuration information indicates to transmit the report in accordance with a combination of events of the plurality of events occurring, wherein the set of events includes the combination of events, and wherein transmitting the report further comprises transmitting the report in accordance with the combination of events occurring.

In some aspects, the combination of events includes a first event associated with a beam prediction accuracy and a second event associated with a link quality.

In some aspects, the configuration information indicates one or more dedicated reference signals corresponding to one or more events of the plurality of events, and method 1100 includes transmitting the one or more dedicated reference signals.

In some aspects, receiving the report further comprises receiving the report via uplink control information or medium access control signaling.

In some aspects, the plurality of events includes at least one of a first event associated with a beam prediction accuracy, a second event associated with a link quality, a third event associated with an input or output data distribution, or a fourth event associated with comparing a measured value and a predicted value.

In some aspects, the configuration information is first configuration information and method 1100 includes transmitting second configuration information updating at least one of an event of the plurality of events or a criterion of the plurality of criteria.

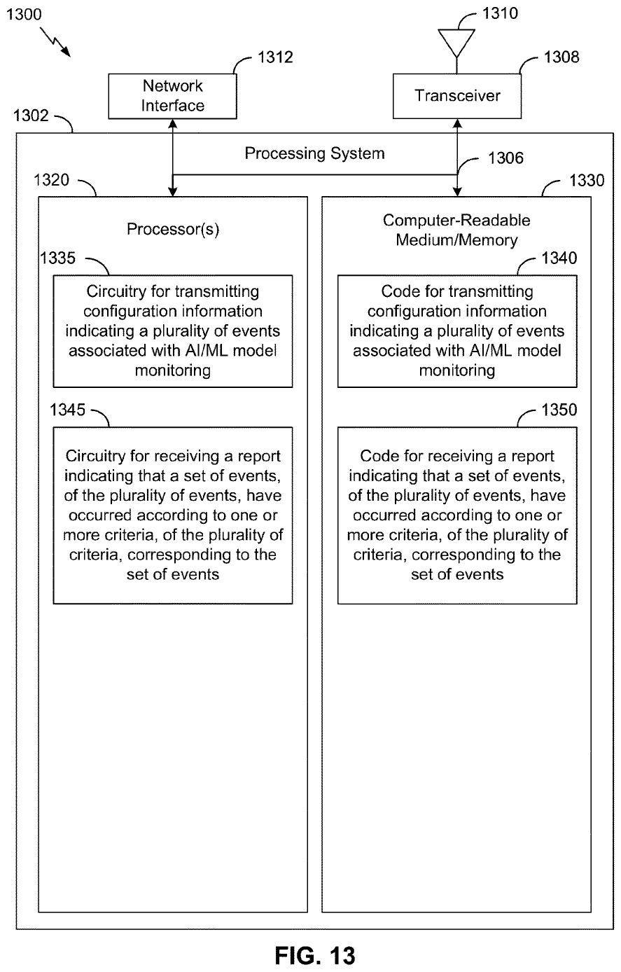

In one aspect, method 1100, or any aspect related to it, may be performed by an apparatus, such as communications device 1300 of FIG. 13, which includes various components operable, configured, or adapted to perform the method 1100.

Communications device 1300 is described below in further detail.

Although FIG. 11 shows example blocks of method 1100, in some aspects, method 1100 may include additional blocks, fewer blocks, different blocks, or differently arranged blocks than those depicted in FIG. 11. Additionally, or alternatively, two or more of the blocks of method 1100 may be performed in parallel.

FIG. 12 is a diagram illustrating an example of an implementation of code and circuitry for a communications device 1200, in accordance with the present disclosure. The communications device 1200 may be a UE, or a UE may include the communications device 1200.

The communications device 1200 includes a processing system 1202 coupled to a transceiver 1208 (e.g., a transmitter and/or a receiver). The transceiver 1208 is configured to transmit and receive signals for the communications device 1200 via an antenna 1210, such as the various signals as described herein. The processing system 1202 may be configured to perform processing functions for the communications device 1200, including processing signals received and/or to be transmitted by the communications device 1200.

The processing system 1202 includes one or more processors 1220. In various aspects, the one or more processors 1220 may be representative of one or more of receive processor 258, transmit processor 264, TX MIMO processor 266, and/or controller/processor 280, as described with respect to FIG. 2. The one or more processors 1220 are coupled to a computer-readable medium/memory 1230 via a bus 1206. In various aspects, the computer-readable medium/memory 1230 may be representative of memory 282, as described with respect to FIG. 2. In certain aspects, the computer-readable medium/memory 1230 is configured to store instructions (e.g., computer-executable code, processor-executable instructions) that when executed by the one or more processors 1220, cause the one or more processors 1220 to perform the method 1000 described with respect to FIG. 10, or any aspect related to it. Note that reference to a processor performing a function of communications device 1200 may include one or more processors performing that function of communications device 1200.

As shown in FIG. 12, the communications device 1200 may include circuitry for receiving configuration information indicating a plurality of events that are associated with AI/ML model monitoring (circuitry 1235).

As shown in FIG. 12, the communications device 1200 may include, stored in computer-readable medium/memory 1230, code for receiving configuration information indicating a plurality of events that are associated with AI/ML model monitoring (code 1240).

As shown in FIG. 12, the communications device 1200 may include circuitry for identifying, according to one or more criteria of the plurality of criteria, that a set of events, of the plurality of events, corresponding to the one or more criteria have occurred (circuitry 1245).

As shown in FIG. 12, the communications device 1200 may include, stored in computer-readable medium/memory 1230, code for identifying, according to one or more criteria of the plurality of criteria, that a set of events, of the plurality of events, corresponding to the one or more criteria have occurred (code 1250).

As shown in FIG. 12, the communications device 1200 may include circuitry for transmitting a report indicating that the set of events have occurred (circuitry 1255).

As shown in FIG. 12, the communications device 1200 may include, stored in computer-readable medium/memory 1230, code for transmitting a report indicating that the set of events have occurred (code 1260).

Various components of the communications device 1200 may provide means for performing the method 1000 described with respect to FIG. 10, or any aspect related to it. For example, means for transmitting, sending, or outputting for transmission may include the transceiver(s) 254 and/or antenna(s) 252 of the UE 120 and/or transceiver 1208 and antenna 1210 of the communications device 1200 in FIG. 12. Means for receiving or obtaining may include the transceiver(s) 254 and/or antenna(s) 252 of the UE 120 and/or transceiver 1208 and antenna 1210 of the communications device 1200 in FIG. 12.

FIG. 12 is provided as an example. Other examples may differ from what is described in connection with FIG. 12.

FIG. 13 is a diagram illustrating an example of an implementation of code and circuitry for a communications device 1300, in accordance with the present disclosure. The communications device 1300 may be a network entity (such as BS 110 or a disaggregated base station as described with regard to FIG. 3), or a network entity may include the communications device 1300.

The communications device 1300 includes a processing system 1302 coupled to a transceiver 1308 (e.g., a transmitter and/or a receiver). The transceiver 1308 is configured to transmit and receive signals for the communications device 1300 via an antenna 1310, such as the various signals as described herein. The network interface 1312 is configured to obtain and send signals for the communications device 1300 via communications link(s), such as a backhaul link, midhaul link, and/or fronthaul link as described herein, such as with respect to FIG. 3. The processing system 1302 may be configured to perform processing functions for the communications device 1300, including processing signals received and/or to be transmitted by the communications device 1300.

The processing system 1302 includes one or more processors 1320. In various aspects, the one or more processors 1320 may be representative of one or more of receive processor 238, transmit processor 220, TX MIMO processor 230, and/or controller/processor 240, as described with respect to FIG. 2. The one or more processors 1320 are coupled to a computer-readable medium/memory 1330 via a bus 1306. In various aspects, the computer-readable medium/memory 1330 may be representative of memory 242, as described with respect to FIG. 2. In certain aspects, the computer-readable medium/memory 1330 is configured to store instructions (e.g., computer-executable code, processor-executable instructions) that when executed by the one or more processors 1320, cause the one or more processors 1320 to perform the method 1100 described with respect to FIG. 11, or any aspect related to it. Note that reference to a processor performing a function of communications device 1300 may include one or more processors performing that function of communications device 1300.

As shown in FIG. 13, the communications device 1300 may include circuitry for transmitting configuration information indicating a plurality of events associated with AI/ML model monitoring (circuitry 1335).

As shown in FIG. 13, the communications device 1300 may include, stored in computer-readable medium/memory 1330, code for transmitting configuration information indicating a plurality of events associated with AI/ML model monitoring (code 1340).

As shown in FIG. 13, the communications device 1300 may include circuitry for receiving a report indicating that a set of events, of the plurality of events, have occurred according to one or more criteria, of the plurality of criteria, corresponding to the set of events (circuitry 1345).

As shown in FIG. 13, the communications device 1300 may include, stored in computer-readable medium/memory 1330, code for receiving a report indicating that a set of events, of the plurality of events, have occurred according to one or more criteria, of the plurality of criteria, corresponding to the set of events (code 1350).

Various components of the communications device 1300 may provide means for performing the method 1100 described with respect to FIG. 11, or any aspect related to it. For example, means for transmitting, sending, or outputting for transmission may include the transceiver(s) 232 and/or antenna(s) 234 of the BS 110 and/or transceiver 1308 and antenna 1310 of the communications device 1300 in FIG. 13. Means for receiving or obtaining may include the transceiver(s) 232 and/or antenna(s) 234 of the BS 110 and/or transceiver 1308 and antenna 1310 of the communications device 1300 in FIG. 13.

FIG. 13 is provided as an example. Other examples may differ from what is described in connection with FIG. 13.

The following provides an overview of some Aspects of the present disclosure:
Aspect 1: A method of wireless communication performed by a user equipment (UE), comprising: receiving configuration information indicating a plurality of events that are associated with artificial intelligence or machine learning (AI/ML) model monitoring, each event of the plurality of events associated with a respective criterion of a plurality of criteria; identifying, according to one or more criteria of the plurality of criteria, that a set of events, of the plurality of events, corresponding to the one or more criteria have occurred; and transmitting a report indicating that the set of events have occurred.
Aspect 2: The method of Aspect 1, wherein the configuration information indicates to transmit the report in accordance with a single event, of the plurality of events, occurring, wherein the set of events includes only the single event, and wherein transmitting the report further comprises transmitting the report in accordance with the single event occurring.
Aspect 3: The method of any of Aspects 1-2, wherein the configuration information indicates to transmit the report in accordance with a combination of events, of the plurality of events, occurring, wherein the set of events includes the combination of events, and wherein transmitting the report further comprises transmitting the report in accordance with the combination of events occurring.
Aspect 4: The method of Aspect 3, wherein the combination of events includes a first event associated with a beam prediction accuracy and a second event associated with a link quality.
Aspect 5: The method of any of Aspects 1-4, wherein the configuration information indicates one or more dedicated reference signals corresponding to one or more events of the plurality of events, wherein identifying that the set of events has occurred further comprises identifying that the one or more criteria are satisfied according to one or more measurements of the one or more dedicated reference signals.
Aspect 6: The method of any of Aspects 1-5, wherein transmitting the report further comprises transmitting the report via uplink control information or medium access control signaling.
Aspect 7: The method of any of Aspects 1-6, wherein the plurality of events includes at least one of: a first event associated with a beam prediction accuracy, a second event associated with a link quality, a third event associated with an input or output data distribution, or a fourth event associated with comparing a measured value and a predicted value.
Aspect 8: The method of any of Aspects 1-7, wherein the configuration information is first configuration information and the method further comprises receiving second configuration information that updates at least one of an event of the plurality of events or a criterion of the plurality of criteria.
Aspect 9: The method of any of Aspects 1-8, further comprising receiving an indication to activate, deactivate, or modify an AI/ML model.
Aspect 10: A method of wireless communication performed by a network entity, comprising: transmitting configuration information indicating a plurality of events associated with artificial intelligence or machine learning (AI/ML) model monitoring, each event of the plurality of events associated with a respective criterion of a plurality of criteria; and receiving a report indicating that a set of events, of the plurality of events, have occurred according to one or more criteria, of the plurality of criteria, corresponding to the set of events.
Aspect 11: The method of Aspect 10, further comprising transmitting an indication to activate, deactivate, or modify an AI/ML model in accordance with the report.
Aspect 12: The method of Aspect 11, wherein transmitting the indication is based at least in part on multiple reports, including the report, relating to multiple events of the plurality of events.
Aspect 13: The method of Aspect 12, wherein each report, of the multiple reports, relates to a respective single event of the multiple events.
Aspect 14: The method of Aspect 11, wherein transmitting the indication is based at least in part on the report relating to a combination of events of the plurality of events.
Aspect 15: The method of any of Aspects 10-14, wherein the configuration information indicates to transmit the report in accordance with a single event of the plurality of events occurring, wherein the set of events includes only the single event, and wherein receiving the report further comprises receiving the report in accordance with the single event occurring.
Aspect 16: The method of any of Aspects 10-15, wherein the configuration information indicates to transmit the report in accordance with a combination of events of the plurality of events occurring, wherein the set of events includes the combination of events, and wherein receiving the report further comprises receiving the report in accordance with the combination of events occurring.
Aspect 17: The method of Aspect 16, wherein the combination of events includes a first event associated with a beam prediction accuracy and a second event associated with a link quality.
Aspect 18: The method of any of Aspects 10-17, wherein the configuration information indicates one or more dedicated reference signals corresponding to one or more events of the plurality of events, and wherein the method further comprises transmitting the one or more dedicated reference signals.
Aspect 19: The method of any of Aspects 10-18, wherein receiving the report further comprises receiving the report via uplink control information or medium access control signaling.
Aspect 20: The method of any of Aspects 10-19, wherein the plurality of events includes at least one of: a first event associated with a beam prediction accuracy, a second event associated with a link quality, a third event associated with an input or output data distribution, or a fourth event associated with comparing a measured value and a predicted value.
Aspect 21: The method of any of Aspects 10-20, wherein the configuration information is first configuration information and the method further comprises transmitting second configuration information updating at least one of an event of the plurality of events or a criterion of the plurality of criteria.
Aspect 22: An apparatus for wireless communication at a device, comprising a processor; memory coupled with the processor; and instructions stored in the memory and executable by the processor to cause the apparatus to perform the method of one or more of Aspects 1-21.
Aspect 23: A device for wireless communication, comprising a memory and one or more processors coupled to the memory, the one or more processors configured to perform the method of one or more of Aspects 1-21.
Aspect 24: An apparatus for wireless communication, comprising at least one means for performing the method of one or more of Aspects 1-21.
Aspect 25: A non-transitory computer-readable medium storing code for wireless communication, the code comprising instructions executable by a processor to perform the method of one or more of Aspects 1-21.
Aspect 26: A non-transitory computer-readable medium storing a set of instructions for wireless communication, the set of instructions comprising one or more instructions that, when executed by one or more processors of a device, cause the device to perform the method of one or more of Aspects 1-21.

The foregoing disclosure provides illustration and description but is not intended to be exhaustive or to limit the aspects to the precise forms disclosed. Modifications and variations may be made in light of the above disclosure or may be acquired from practice of the aspects.

Reference to an element in the singular is not intended to mean only one unless specifically so stated, but rather “one or more.” For example, reference to an element (e.g., “a processor,” “a controller,” “a memory,” etc.), unless otherwise specifically stated, should be understood to refer to one or more elements (e.g., “one or more processors,” “one or more controllers,” “one or more memories,” etc.).

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules, and circuits described in connection with the present disclosure may be implemented or performed with a general purpose processor, a digital signal processor (DSP), an application-specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices (e.g., a combination of a DSP and a microprocessor, a plurality of microprocessors, one or more microprocessors in conjunction with a DSP core, a system on a chip (SoC), or any other such configuration).

As used herein, the term “determining” encompasses a wide variety of actions. For example, “determining” may include calculating, computing, processing, deriving, investigating, looking up (e.g., looking up in a table, a database, or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or a processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. An apparatus for wireless communication, comprising:
one or more memories comprising processor-executable instructions; and
one or more processors configured to execute the processor-executable instructions and cause the apparatus to:
receive configuration information indicating a plurality of events that are associated with artificial intelligence or machine learning (AI/ML) model monitoring, each event of the plurality of events associated with a respective criterion of a plurality of criteria;
identify, according to one or more criteria of the plurality of criteria, that a set of events, of the plurality of events, corresponding to the one or more criteria have occurred; and
transmit a report indicating that the set of events have occurred.

2. The apparatus of claim 1, wherein the configuration information indicates to transmit the report in accordance with a single event, of the plurality of events, occurring, wherein the set of events includes only the single event, and wherein the one or more processors, to cause the apparatus to transmit the report, are further configured to cause the apparatus to transmit the report in accordance with the single event occurring.

3. The apparatus of claim 1, wherein the configuration information indicates to transmit the report in accordance with a combination of events, of the plurality of events, occurring, wherein the set of events includes the combination of events, and wherein the one or more processors, to cause the apparatus to transmit the report, are further configured to cause the apparatus to transmit the report in accordance with the combination of events occurring.

4. The apparatus of claim 3, wherein the combination of events includes a first event associated with a beam prediction accuracy and a second event associated with a link quality.

5. The apparatus of claim 1, wherein the configuration information indicates one or more dedicated reference signals corresponding to one or more events of the plurality of events, wherein the one or more processors, to cause the apparatus to identify that the set of events has occurred, are further configured to cause the apparatus to identify that the one or more criteria are satisfied according to one or more measurements of the one or more dedicated reference signals.

6. The apparatus of claim 1, wherein, to cause the apparatus to transmit the report, the one or more processors are further configured to cause the apparatus to transmit the report via uplink control information or medium access control signaling.

7. The apparatus of claim 1, wherein the plurality of events includes at least one of:
a first event associated with a beam prediction accuracy,
a second event associated with a link quality,
a third event associated with an input or output data distribution, or
a fourth event associated with comparing a measured value and a predicted value.

8. The apparatus of claim 1, wherein the configuration information is first configuration information and the one or more processors are further configured to cause the apparatus to receive second configuration information that updates at least one of an event of the plurality of events or a criterion of the plurality of criteria.

9. The apparatus of claim 1, wherein the one or more processors are further configured to cause the apparatus to receive an indication to activate, deactivate, or modify an AI/ML model.

10. An apparatus for wireless communication, comprising:
one or more memories comprising processor-executable instructions; and
one or more processors configured to execute the processor-executable instructions and cause the apparatus to:
transmit configuration information indicating a plurality of events associated with artificial intelligence or machine learning (AI/ML) model monitoring, each event of the plurality of events associated with a respective criterion of a plurality of criteria; and
receive a report indicating that a set of events, of the plurality of events, have occurred according to one or more criteria, of the plurality of criteria, corresponding to the set of events.

11. The apparatus of claim 10, wherein the one or more processors are further configured to cause the apparatus to transmit an indication to activate, deactivate, or modify an AI/ML model in accordance with the report.

12. The apparatus of claim 11, wherein the indication is based at least in part on the report relating to a combination of events of the plurality of events, or wherein the indication is based at least in part on multiple reports, including the report, relating to multiple events of the plurality of events, wherein each report, of the multiple reports, relates to a respective single event of the multiple events.

13. (canceled)

14. (canceled)

15. The apparatus of claim 10, wherein the configuration information indicates to transmit the report in accordance with a single event of the plurality of events occurring, wherein the set of events includes only the single event, and wherein the one or more processors, to cause the apparatus to receive the report, are configured to cause the apparatus to receive the report in accordance with the single event occurring.

16. The apparatus of claim 10, wherein the configuration information indicates to transmit the report in accordance with a combination of events of the plurality of events occurring, wherein the set of events includes the combination of events, and wherein the one or more processors, to cause the apparatus to receive the report, are configured to cause the apparatus to receive the report in accordance with the combination of events occurring.

17. The apparatus of claim 16, wherein the combination of events includes a first event associated with a beam prediction accuracy and a second event associated with a link quality.

18. The apparatus of claim 10, wherein the configuration information indicates one or more dedicated reference signals corresponding to one or more events of the plurality of events, and wherein the one or more processors are further configured to cause the apparatus to transmit the one or more dedicated reference signals.

19. The apparatus of claim 10, wherein, to cause the apparatus to receive the report, the one or more processors are configured to cause the apparatus to receive the report via uplink control information or medium access control signaling.

20. The apparatus of claim 10, wherein the plurality of events includes at least one of:
a first event associated with a beam prediction accuracy,
a second event associated with a link quality,
a third event associated with an input or output data distribution, or
a fourth event associated with comparing a measured value and a predicted value.

21. The apparatus of claim 10, wherein the configuration information is first configuration information and the one or more processors are further configured to cause the apparatus to transmit second configuration information updating at least one of an event of the plurality of events or a criterion of the plurality of criteria.

22. A method of wireless communication performed by a user equipment (UE), comprising:
receiving configuration information indicating a plurality of events that are associated with artificial intelligence or machine learning (AI/ML) model monitoring, each event of the plurality of events associated with a respective criterion of a plurality of criteria;
identifying, according to one or more criteria of the plurality of criteria, that a set of events, of the plurality of events, corresponding to the one or more criteria have occurred; and
transmitting a report indicating that the set of events have occurred.

23. (canceled)
